(19) United States
(12) Patent Application Publication
(10) Pub. No.: US 2025/0301496 A1
(43) Pub. Date: Sep. 25, 2025

(54) METHODS OF SIDELINK OPERATIONS FOR BEAM-BASED MODE 2 SL TCI ADAPTATION IN SHARED SPECTRUM

(71) Applicant: InterDigital Patent Holdings, Inc., Wilmington, DE (US)

(72) Inventors: Kyle Jung-Lin Pan, Saint James, NY (US); Ravikumar Pragada, Warrington, PA (US); Yifan Li, Conshohocken, PA (US); Pascal Adjakple, Great Neck, NY (US)

(73) Assignee: InterDigital Patent Holdings, Inc., Wilmington, DE (US)

(21) Appl. No.: 19/112,466

(22) PCT Filed: Oct. 5, 2023
(86) PCT No.: PCT/US23/76103

§ 371 Date: Mar. 17, 2025

Related U.S. Application Data
(60) Provisional application No. 63/413,449, filed on Oct. 5, 2022.

(51) Int. Cl. H04W 74/00; H04L 5/00

(52) U.S. Cl. CPC H04W 74/002; H04L 5/0053

(57) ABSTRACT

A WTRU may be configured to receive configuration information that comprises a sidelink (SL) secondary transmission configuration indication (S-TCI) mode indicator set to enabled. The WTRU may receive a first stage SL control information (SCI) that indicates one or more SL primary transmission configuration indications (SL P-TCIs). The WTRU may determine whether to disable the SL S-TCI mode indicator for a second stage SCI based on channel uncertainty. The WTRU may receive the second stage SCI. The WTRU, in response to the SL S-TCI indicator remaining enabled for the second stage SCI, may determine one or more SL S-TCIs using the second stage SCI. The WTRU may receive a physical sidelink shared channel (PSSCH) transmission using the one or more SL P-TCIs and/or the one or more SL S-TCIs based on the SL S-TCI mode indicator being enabled for the second stage SCI.

### CROSS-REFERENCE TO RELATED APPLICATIONS

This application claims priority to U.S. Provisional Patent Application No. 63/413,449, filed Oct. 5, 2022, the entire contents of which are incorporated herein by reference in its entirety.

### BACKGROUND

A new radio vehicle to everything (NR V2X) may be designed with a broader set of more advanced V2X use cases. A NR V2X may be broadly arranged into four use case groups: vehicular platooning, extended sensors, advanced driving, and remote driving.

Vehicular platooning may enable the vehicles to dynamically form a platoon when travelling together. All the vehicles in the platoon obtain information from the leading vehicle to manage this platoon. The information from the leading vehicle allows the vehicles to drive closer than normal and in a coordinated manner (e.g., going to the same direction and travelling together).

Extended sensors may enable the exchange of raw or processed data gathered through local sensors, live video images among vehicles, road site units, devices of pedestrians, and/or V2X application servers. The vehicles may increase the perception of their environment beyond what their own sensors can detect. The vehicles may have a more broad and holistic view of the local situation. A key characteristic of extended sensors is high data rate.

Advanced driving may enable semi-automated and/or full-automated driving. Each vehicle and/or roadside unit (RSU) may share its own perception data obtained from its local sensors with vehicles in proximity. This sharing of data may allow vehicles to synchronize and/or coordinate their trajectories or maneuvers. Each vehicle may share its driving intention with vehicles in proximity.

Remote driving may enable a remote driver and/or a V2X application to operate a remote vehicle for passengers who cannot drive by themselves and/or remote vehicles located in dangerous environments. For a case with limited variation and/or predictable routes (e.g., public transportation), driving based on cloud computing may be used. Main requirements of remote driving may include high reliability and/or low latency.

### SUMMARY

Methods of beam-based mode 2 resource allocation and sidelink (SL) transmission configuration indication (SL TCI) mechanism in unlicensed spectrum are proposed. Hereinafter, TCI may also refer to transmission configuration indicator,

A WTRU performs beam and TCI adaptation (e.g., in shared spectrum to increase reception opportunities; enhance performance and reduced signaling overhead). The WTRU may be pre-configured for the TCI configuration. Depending on channel uncertainty, a SL secondary TCI (S-TCI) mode indicator may be set properly. If channel uncertainty is high, the SL S-TCI mode indicator in the first stage sidelink control information (SCI) may be set to “enabled.” If channel uncertainty is low, the SL S-TCI mode indicator in the first stage SCI may be set to “disabled.”

A WTRU may be indicated TCI (e.g., via sidelink medium access control control element (SL MAC CE) to receive the first stage SCI and/or second stage SCI. The WTRU may receive the first stage SCI and obtain SL primary TCI (SL P-TCI(s). If the SL S-TCI mode indicator is configured, then the WTRU may further check channel uncertainty. If channel uncertainty is high, then the SL S-TCI mode indicator is set to “enabled.” If channel uncertainty is low, then SL S-TCI mode indicator is set to “disabled.”

A WTRU may receive the second stage SCI to obtain additional TCI information. If the SL S-TCI mode indicator (in first stage SCI) indicates “enabled,” then the WTRU may check additional control field and obtain additional TCIs (e.g., SL S-TCI(s) in the second stage SCI. The WTRU may receive physical sidelink shared channel (PSSCH) using both SL P-TCI(s) and SL S-TCI(s) to increase reception opportunities and enhance performance.

When a WTRU receives the first stage SCI, the WTRU may check SL S-TCI mode indicator in control field of the first stage SCI. If the SL S-TCI mode indicator (e.g., in first stage SCI) indicates “disabled,” then the additional control field for SL S-TCI may not be present and WTRU may not obtain SL S-TCI in the second stage SCI. The WTRU may receive PSSCH using SL P-TCI(s) (e.g., only the SL P-TCI(s)) to reduce signaling overhead.

Methods of beam-based Mode 2 resource allocation and/or SL TCI mechanism in unlicensed spectrum may proposed. If the SL S-TCI mode indicator is not configured, then the WTRU may not check channel uncertainty. An additional control field for SL S-TCI may not be present and the WTRU may not obtain SL S-TCI in the second stage SCI. The WTRU may receive a PSSCH using SL P-TCI(s) (e.g., only the SL P-TCI(s).

A WTRU may perform beam and/or TCI adaptation (e.g., in shared spectrum to increase reception opportunities, enhance performance and/or reduced signaling overhead). A WTRU may be pre-configured for TCI configuration. Depending on channel uncertainty, the SL S-TCI mode indicator may be set properly. If channel uncertainty is high, then SL S-TCI mode indicator (in first stage SCI) may be set to “enabled.” If channel uncertainty is low, then SL S-TCI mode indicator (in first stage SCI) may be set to “disabled.”

A WTRU may be indicated for TCI (e.g., via SL MAC CE) to receive the first stage SCI and second stage SCI. The WTRU may receive the first stage SCI and obtain SL P-TCI(s). If a SL S-TCI mode indicator is configured, then the WTRU may further check channel uncertainty. If channel uncertainty is high, then the SL S-TCI mode indicator is set to “enabled.” If channel uncertainty is low, then the SL S-TCI mode indicator is set to “disabled.”

A WTRU may receive the second stage SCI to obtain additional TCI information. If the SL S-TCI mode indicator (in first stage SCI) indicates “enabled,” then the WTRU may check additional control field and obtain additional TCIs (e.g., SL S-TCI(s) in the second stage SCI). A WTRU may receive a PSSCH using both SL P-TCI(s) and/or SL S-TCI(s) to increase reception opportunities and/or enhance performance.

When a WTRU receives the first stage SCI, the WTRU may check the SL S-TCI mode indicator in control field of the first stage SCI.

If the SL S-TCI mode indicator (e.g., in first stage SCI) indicates “disabled,” then additional control field for SL S-TCI may not be present and the WTRU may not obtain the SL S-TCI in the second stage SCI. The WTRU may receive a PSSCH using SL P-TCI(s) (e.g., only the SL P-TCI(s) to reduce signaling overhead.

If the SL S-TCI mode indicator is not configured, then the may not check channel uncertainty. An additional control field for the SL S-TCI may not be present and the WTRU may not obtain the SL S-TCI in the second stage SCI. The WTRU may receive a PSSCH using SL P-TCI(s) (e.g., only the SL P-TCI(s).

A WTRU may be configured to receive configuration information that comprises a SL S-TCI mode indicator set to enabled. The WTRU may receive a first stage SL control information (SCI) that indicates one or more SL P-TCIs. The WTRU may determine whether to disable the SL S-TCI mode indicator for a second stage SCI based on channel uncertainty. The WTRU may receive the second stage SCI. The WTRU, in response to the SL S-TCI indicator remaining enabled for the second stage SCI, may determine one or more SL S-TCIs using the second stage SCI. The WTRU may receive a physical sidelink shared channel (PSSCH) transmission using the one or more SL P-TCIs and/or the one or more SL S-TCIs based on the SL S-TCI mode indicator being enabled for the second stage SCI.

The WTRU may determine the channel uncertainty based on one or more channel uncertainty measurements. The WTRU may determine that the channel uncertainty is high based on the one or more channel uncertainty measurements being greater than a predetermined threshold. The WTRU may enable the SL S-TCI mode indicator based on the channel uncertainty being determined as high. The WTRU may disable the SL S-TCI mode indicator based on the channel uncertainty being determined as low.

The WTRU may include one or more of a number of listen before talk (LBT) failures, a ratio of LBT failures to total measurements, a ratio of LBT failures to successes, a negative acknowledgment (NACK) to acknowledgment (ACK) ratio, a percentage of NACKs, a channel busy ratio (CBR), and/or an interference level. The one or more SL S-TCIs are determined based on a control field in the second stage SCI. The second stage SCI may be received using the SL P-TCI. The WTRU may receive a SL MAC CE that indicates a SL TCI to be used to receive the first stage SCI and/or the second stage SCI.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a diagram depicting an example 5G vehicle to everything (V2X) versus long term evolution vehicle to vehicle (LTE V2V) requirement.

FIG. 3 is a flow chart depicting an example method of sidelink (SL) 2-stage sidelink control information (SCI) based transmission configuration indication (TCI) indication.

FIG. 4 is a flow chart depicting another example method of sidelink 2-stage SCI based TCI indication.

FIG. 5 is a flow chart depicting an example method of sidelink 2-stage SCI based SL TCI indication (configurable SL secondary TCI (SL S-TCI) mode indicator).

FIG. 6 is a flow chart depicting an example method of TCI adaptation.

FIG. 7 is a diagram depicting an example scenario for physical sidelink shared channel (PSSCH) multiplexed with second SCI in frequency domain and second SCI multiplexed with PSSCH in time domain.

FIG. 8 is a diagram depicting another example scenario for PSSCH multiplexed with second SCI in frequency domain and second SCI multiplexed with PSSCH in time domain.

FIG. 9 is a diagram depicting an example scenario for second SCI multiplexed with PSSCH in time domain.

FIG. 10 is a diagram depicting an example scenario for second SCI multiplexed with PSSCH in frequency domain.

FIG. 11 is a flow chart depicting an example method of channel uncertainty determination.

FIG. 12 is a flow chart depicting another example method of channel uncertainty determination.

FIG. 13 is a flow chart depicting an example method of TCI adaptation.

FIG. 14 is a flow chart depicting another example method of TCI adaptation.

### DETAILED DESCRIPTION

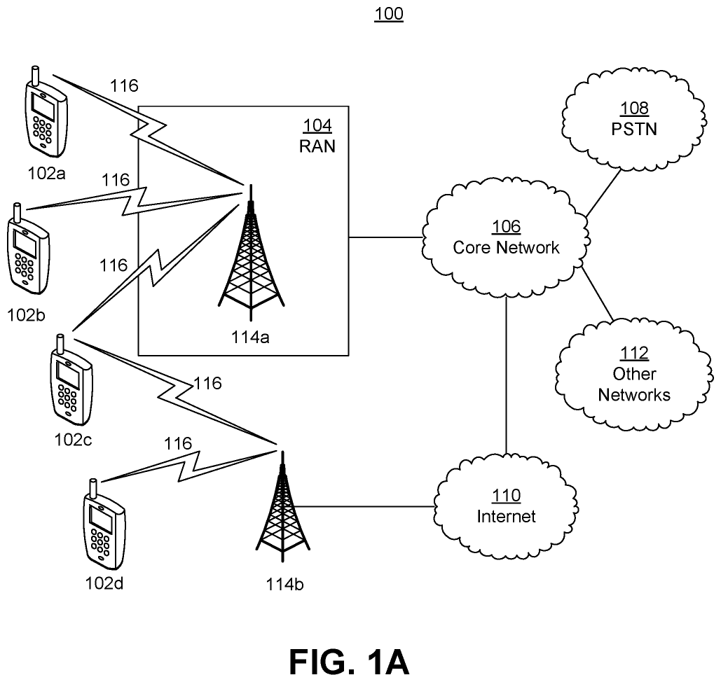

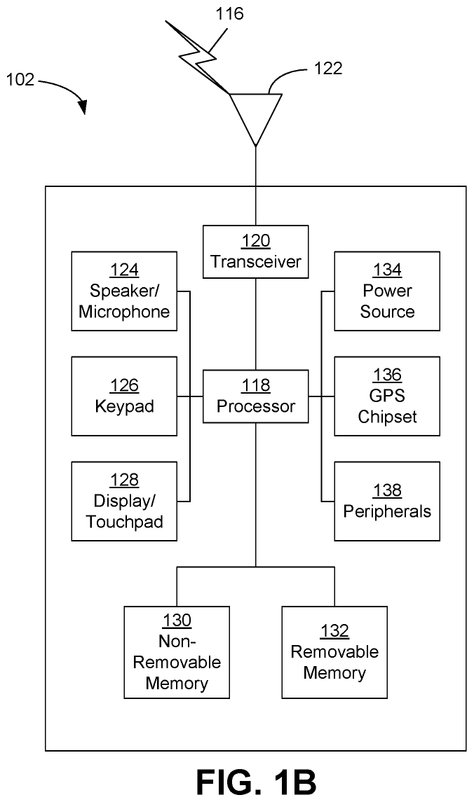

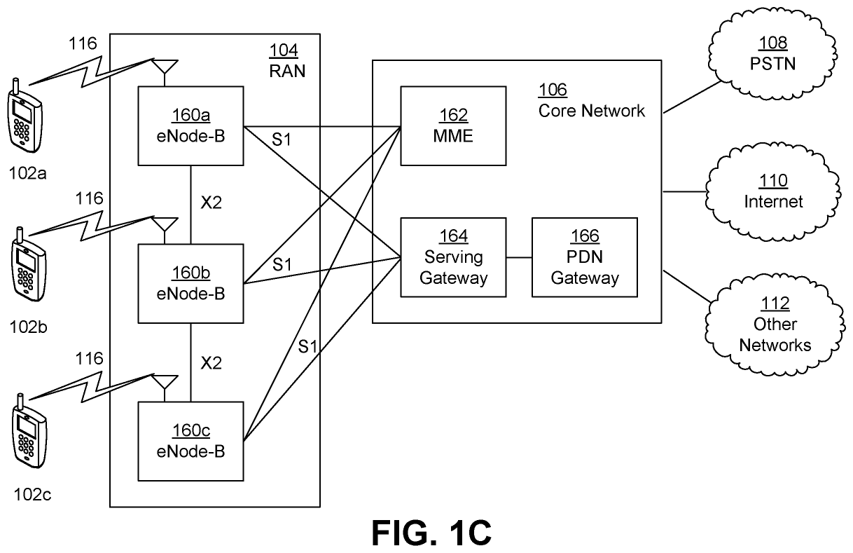

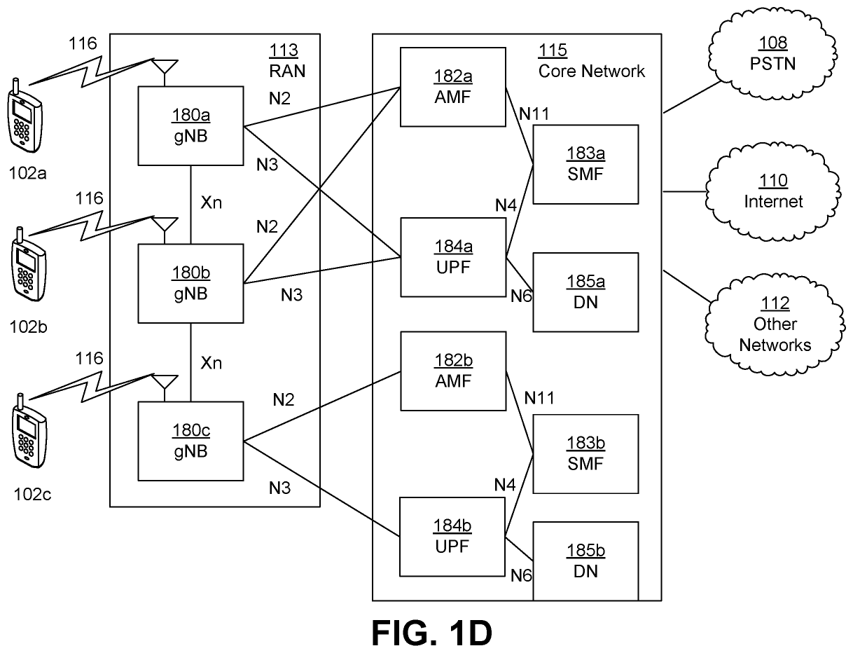

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (e.g., which may support only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct radio frequency (RF) coupling and/or wireless communications via RF circuitry (e.g., which may include one or more antennas) may be used by the emulation devices to transmit and/or receive data.

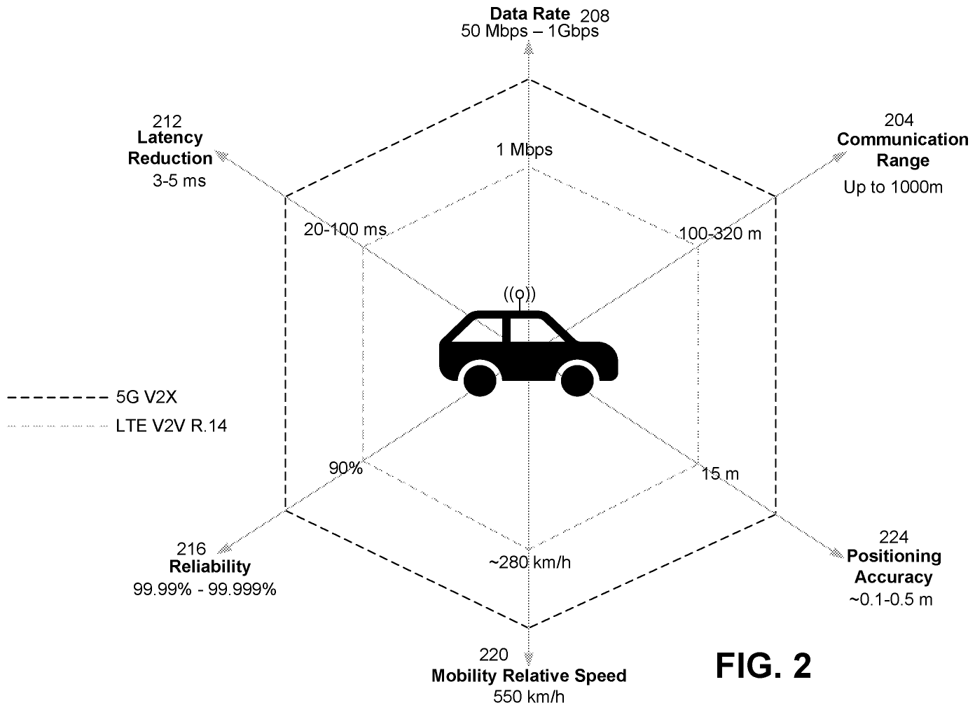

FIG. 2 is a diagram of 5G vehicle to everything (V2X) versus long term evolution vehicle to vehicle (LTE V2V) requirement. Pictured in FIG. 2 is a representation of the most demanding requirements for 5G V2X (in contrast to the requirements of LTE V2V), which may include a maximum sidelink range of 1000 m at 204, a maximum throughput of 1.0 Gbps at 208, a shortest latency of 3.0 ms at 212, a maximum reliability of 99.999% at 216, and/or a maximum transmission rate of 100 messages/s. Other challenging requirements may also include mobility relative speed, which may have a maximum of 550 km/h at 220 and/or positioning accuracy, which may be as small as ˜0.1 m at 224. There may not be a use case which, on its own, demands all of these bounding requirements. Further requirements may include security, integrity, authorization, and/or privacy.

The new radio vehicle to everything NR V2X has physical layer support for broadcast, unicast, and/or groupcast sidelink operation. The addition of unicast and/or groupcast may be linked with the introduction of sidelink hybrid automatic repeat request (HARQ) feedback, high order modulation, sidelink channel state information (CSI), and/or PC5-radio resource control (RRC), etc.

The NR V2X sidelink may use one or more physical channels and/or signals including physical sidelink broadcast channel (PSBCH) and its demodulation reference signal (DMRS), physical sidelink control channel (PSCCH) and its DMRS, physical sidelink shared channel (PSSCH) and its DMRS, physical sidelink feedback channel (PSFCH), and/or sidelink primary and secondary synchronization signals (S-PSS and/or S-SSS) which may be organized into the sidelink synchronization signal block (S-SSB) together with PSBCH. S-PSS and S-SSS may be referred to jointly as the sidelink synchronization signal (SLSS), phase-tracking reference signal (PT-RS) in FR2, and/or channel state information reference signal (CSI-RS).

The NR-V2X sidelink may support subcarrier spacings of 15, 30, 60 and/or 120 kHz. These subcarrier spacings may be associated to cyclic prefixes (CPs) and frequency ranges for NR uplink/downlink (UL/DL), but using the cyclic prefix orthogonal frequency division multiplexing CP-OFDM waveform (e.g., only the CP-OFDM waveform). The modulation schemes available may include quadrature phase shift keying (QPSK), 16-quadrature amplitude modulation QAM, 64-QAM, and/or 256-QAM.

The PSBCH may transmit the sidelink broadcast channel (SL-BCH) transport channel which carries the sidelink V2X Master Information Block (MIB-V2X) from the RRC layer. The PSBCH may transmit the master information block (MIB)-V2X every 160 ms in 11 RBs of the SL bandwidth, with possible repetitions in the period. DMRS associated with PSBCH may be transmitted in every symbol of the S-SSB slot. S-PSS and S-SSS may be transmitted together with PSBCH in the S-SSB. They jointly convey the SLSS ID used by the WTRU.

Sidelink control information (SCI) in the NR V2X may be transmitted in two stages. PSCCH may carry the first-stage SCI and contain information (e.g. to enable sensing operations and/or information about the resource allocation of the PSSCH).

PSSCH may transmit the second-stage SCI and/or the SL-SCH transport channel. The second-stage SCI may carry information (e.g. information needed to identify and/or decode the associated SL-SCH, as well as control for HARQ procedures, and/or triggers for CSI feedback, etc.). SL-SCH may carry the transport block (TB) of data for transmission over SL.

A gNB may schedule or configure the resources the PSSCH may transmit. The transmitting WTRU may determine the resources the PSSCH through a sensing procedure the WTRU conducts autonomously. A given transport block (TB) may be transmitted multiple times. DMRS associated with rank-1 and/or rank-2 PSSCH may be transmitted in 2, 3, or 4 sidelink symbols distributed through a sidelink slot. Multiplexing between PSCCH and/or PSSCH may be in time and frequency within a slot.

A PSFCH may carry HARQ feedback over the sidelink from a WTRU. The WTRU may be an intended recipient of a PSSCH transmission. A WTRU that is the intended recipient of a transmission will be referred to as a Rx WTRU, and a WTRU that performed the transmission will be referred to as a Tx WTRU. Sidelink HARQ feedback may be in the form of conventional acknowledgement and/or non-acknowledgement (ACK/NACK), and/or NACK-only with nothing transmitted in case of successful decoding. The PSFCH transmits a Zadoff-Chu sequence in one PRB repeated over two OFDM symbols. The first OFDM symbol may be used for AGC, near the end of the sidelink resource, in a slot. The time resources for the PSFCH may be pre-configured to occur once in every 1, 2, or 4 slots.

Mode 1 is for resource allocation by a gNB. A NR V2X may generate a diverse array of periodic and/or aperiodic message types. Therefore, resource allocation mode 1 may provide dynamic grants of sidelink resources from a gNB and/or grants of periodic sidelink resources configured semi-statically by the RRC.

A dynamic sidelink grant downlink control information (DCI) may provide resources for one or multiple transmissions of a transport block to allow control of reliability. The one or multiple transmission(s) may be subject to the sidelink HARQ procedure, if the HARQ procedure were enabled.

A sidelink configured grant may be configured once and used by the WTRU (e.g., immediately), for example, until RRC signaling, known as Type 1, releases the sidelink configured grant. A WTRU may be allowed to continue using this type of sidelink configured grant when beam failure or physical layer problems occur in NR Uu until a radio link failure (RLF) detection timer expires, before falling back to an exception resource pool. Another type of sidelink configured grant, known as Type 2, may be configured once but cannot be used until the gNB sends the WTRU a DCI indicating the sidelink configure grant is now active, and until (e.g., only until) another DCI indicates de-activation. The resources in both Type 1 and/or Type 2 may be a set of sidelink resources recurring with a periodicity which a gNB will desire to match to the characteristics of the V2X traffic. Multiple configured grants may be configured to allow provision for different services (e.g., traffic types, etc.).

MCS information for dynamic and configured grants may be provided and/or constrained by a RRC signaling instead of the traditional DCI. The RRC may configure the exact MCS the Tx WTRU uses, and/or a range of MCS. The MCS may also be left unconfigured. In some examples where RRC does not provide the exact MCS, the Tx WTRU may be left to select an appropriate MCS itself. The Tx WTRU may be left to select an appropriate MCS based on the knowledge the Tx WTRU has of the TB to be transmitted and/or the sidelink radio conditions.

The Mode 2 may be for the WTRU autonomous resource selection. The Mode 2's basic structure may be of a WTRU sensing, within a pre-configured resource pool, resources unused by other WTRUs with higher-priority traffic, and/or choosing an appropriate amount of the unused resources for its own transmissions. The WTRU may transmit and/or re-transmit the selected resources a certain number of times and/or until a cause of resource reselection is triggered.

The Mode 2 sensing procedure may select and reserve resources for a variety of purposes (e.g., reflecting that the NR V2X introduces sidelink HARQ in support of unicast and groupcast in the physical layer). The Mode 2 may reserve resources used for a number of blind re-transmissions and/or HARQ-feedback-based re-transmissions of a transport block. When the Mode 2 reserves resources for a number of blind re-transmissions or HARQ-feedback-based re-transmissions of a transport block, the resources may be indicated in the SCI(s) scheduling the transport block. Additionally or alternatively, the Mode 2 may select resources used for the initial transmission of a later transport block. When the Mode 2 selects resources used for the initial transmission of a later transport block, the resources may be indicated in an SCI scheduling a current transport block. An initial transmission of a transport block may be performed after sensing and/or resource selection, but without a reservation.

The first-stage SCIs transmitted by WTRUs on PSCCH may indicate the time-frequency resources in which the WTRU may transmit a PSSCH. These SCI transmissions may be used by sensing the WTRUs and/or maintaining a record of which other WTRUs recently reserved which resources.

The sensing WTRU may then select resources for its re-transmission(s) from within a resource selection window. The window may start shortly after the trigger for re-selection of resources. The window may not be longer than the remaining latency budget of the packet due to be transmitted. The reserved resources in the selection window with SL-RSRP above a threshold may be excluded from being candidates by the sensing WTRU, with the threshold set according to the priorities of the traffic of the sensing and the transmitting WTRUs. Thus, a higher priority transmission from a sensing WTRU may occupy resources reserved by a transmitting WTRU with sufficiently low SL-RSRP and sufficiently lower-priority traffic.

Bandwidth parts (BWPs) may be defined for the sidelink in a similar way as for UL/DL, such as providing a convenient way to specify aspects relating to a WTRU's radio frequency (RF) hardware chain implementation. A WTRU may be configured with one active sidelink BWP when in connected mode to a gNB, which is the same as the single sidelink BWP used for idle mode or out-of-coverage operation.

The subcarrier spacing used on sidelink may be provided in the sidelink BWP pre-configuration, from the same set of values and associations to frequency ranges as for the Uu interface (e.g., 15, 30, or 60 kHz for FR1 and 60 or 120 KHz for FR2). The sidelink transmission and/or reception for a WTRU are thus contained within a sidelink BWP, and the same sidelink BWP may be used for both transmitting and/or receiving. This means that resource pools, S-SSB, and the like must also be contained within an appropriate sidelink BWP from the WTRU's perspective.

To support a wide range of services, a 5G NR system aims to be flexible enough to meet the connectivity requirements of a range of existing and future services in an efficient manner. For example, NR may consider supporting potential use of frequency range up to 100 GHz.

The NR specifications developed in Rel-15 and Rel-16 define operation for frequencies up to 52.6 GHz, where all physical layer channels, signals, procedures, and/or protocols may be designed to be optimized for uses under 52.6 GHz.

Frequencies above 52.6 GHz may be faced with more difficult challenges (e.g., higher phase noise, larger propagation loss due to high atmospheric absorption, lower power amplifier efficiency, and/or strong power spectral density regulatory requirements in unlicensed bands as compared to lower frequency bands). Additionally or alternatively, the frequency ranges above 52.6 GHz may contain larger spectrum allocations and larger bandwidths that may not be available for bands lower than 52.6 GHz.

As an initial effort to enable and/or optimize 3GPP NR system for operation in above 52.6 GHz, 3GPP RAN has studied requirements for NR beyond 52.6 GHz. Specifically, 3GPP RAN has studied requirements for NR up to 114.25 GHz, including global spectrum availability and regulatory requirements (including channelization and licensing regimes); potential use cases and/or deployment scenarios; and/or NR system design requirements and/or considerations on top of regulatory requirements. The potential use cases identified in the study include high data rate enhanced mobile broadband (eMBB), mobile data offloading, short range high-data rate device-to-device (D2D) communications, broadband distribution networks, integrated access backhaul (IAB), factory automation, industrial IoT (IIoT), wireless display transfer, augmented reality (AR) and/or virtual reality (VR) wearables, intelligent transport systems (ITS) and V2X, data center inter-rack connectivity, smart grid automation, private networks, and/or support of high positioning accuracy. The use cases span over several deployment scenarios identified in the study. The deployment scenarios include, but are not limited to: indoor hotspot, dense urban, urban micro, urban macro, rural, factor hall, and/or indoor D2D scenarios. The study also identified several system design requirements around waveform, multiple input multiple output (MIMO) operation, device power consumption, channelization, bandwidth, range, availability, connectivity, and/or spectrum regime considerations, etc.

Frequencies of interest in the short term include frequencies between 52.6 GHz and 71 GHz because of their proximity to sub-52.6 GHz. Under these frequencies the current NR system may be optimized and/or the imminent commercial opportunities for high data rate communications, (e.g., unlicensed spectrum but also licensed spectrum between 57 GHz and 71 GHz).

The NR Rel-15 has defined the two frequency ranges, frequency range (FR1) spanning from 410 MHz to 7.125 GHz and FR2 spanning from 24.25 GHz to 52.6 GHz, for operation.

The proximity of this frequency range (57-71 GHz) to FR2 and the imminent commercial opportunities for high data rate communications compels 3GPP to address the NR operation in this frequency regime. To minimize the specification burden and maximize the leverage of FR2 based implementations, 3GPP has decided to extend FR2 operation up to 71 GHz with the adoption of one or more new numerologies (e.g., larger subcarrier spacings). New numerologies may be identified by the study on waveform for NR>52.6 GHz.

The new radio unlicensed (NR-U) defined procedures for operation in unlicensed spectrum may also be leveraged towards operation in the unlicensed 60 GHz band. NR operation may support up to 71 GHz and consider both licensed and/or unlicensed operation. Similar to regular NR and/or NR-U operations below 52.6 GHz, NR/NR-U operation in the 52.6 GHz to 71 GHz may be in stand-alone or aggregated via CA and/or DC with an anchor carrier.

In Rel-16 NR-U, the supported numerology (e.g. SCS) may be set as 15, 30 and 60 KHz, respectively. The listen before talk (LBT) bandwidth is set to 20 MHz in Rel-16 NR-U. Based on the minimum LBT bandwidth which must be supported, the DL initial BWP is nominally 20 MHz for Rel-16 NR-U. The maximum supported channel bandwidth may be set to 100 MHz. The WTRU channel bandwidth (or an activated BWP) may be set as an integer multiple of LBT bandwidth (e.g., 20 MHz). For example, for SCS equal to 30 KHz, the total allocated PRB numbers for 20 MHz, 40 MHz and 80 MHz bandwidth equals 48, 102, and 214, respectively.

Rel-18 may cover sidelink communication with FR1 unlicensed channel access (e.g., no beam management (BM)) for Mode 2 and FR2 licensed operation with BM. Unlicensed channel access and/or physical channel design (e.g. only unlicensed channel access and/or physical channel design) may be considered for FR1. BM (e.g., only BM) may be considered for licensed spectrum. Rel-18 does not consider FR2 unlicensed operation with BM. Rel-18 may consider unicast communication. Rel-18 may not consider other cast types.

In beam-based SL in unlicensed bands and/or shared spectrum, due to channel uncertainty, signal and/or channel may not be transmitted due to LBT failure in certain spatial direction. Even if signal and/or channel may be transmitted in certain spatial direction, signal and/or channel may not be received due to interference (e.g., from hidden node in certain spatial direction). An unlicensed beam-based SL system therefore requires a mechanism to increase transmission and/or receiving opportunities. The unique two-stage control design in the SL requires incorporation of transmission configuration indication (TCI) framework into the SL to increase transmission and/or receiving opportunities in an unlicensed spectrum. (Hereinafter, TCI may also refer to transmission configuration indicator.) The beam-based unlicensed band has an additional dimension in the spatial domain and/or frequency-time domain. Resource allocation in the beam-based unlicensed band may be impacted by channel uncertainty and/or spatial domain. For example, beam-based unlicensed spectrum and/or shared spectrum may be required to directionality transmit and/or receive beams into resource allocation to cope with channel uncertainty.

One or more methods of beam-based mode 2 resource allocation and SL TCI mechanism in unlicensed spectrum may be provided. To optimize beam-based Mode 2 resource allocation, the Rx WTRU may create more reception opportunities. To optimize beam-based Mode 2 resource allocation, the Tx WTRU may create more transmission opportunities. The Rx beam for the Rx WTRU may be indicated in TCI to assist reception beamforming at the Rx. The Tx beam for the Tx WTRU may be indicated in TCI to assist transmission beamforming at the Tx WTRU. More than one TCI may be indicated for PSSCH reception or transmission. In examples, the WTRU may indicate TCI(s) in the first stage SCI; the second stage SCI; joint SCIs; and/or the first stage SCI and/or additional TCI(s) in the second stage SCI. Additionally or alternatively, TCI(s) bits may be split and carried and/or indicated in both the first stage SCI and/or second stage SCI. In examples, the WTRU may indicate TCI(s) in medium access control control element (MAC CE) and/or in joint SCI and MAC CE.

A TCI may be indicated in the first stage SCI, second stage SCI, PSSCH, MAC CE, PC5-RRC, new SCI or else, and/or combination of them. The TCI may be indicated using a plurality of methods, (e.g. a 2-stage approach, multi-stage approach, split approach, joint approach, one-stage approach, etc.). Utilizing primary TCI may cope with channel uncertainty in unlicensed spectrum. Introducing secondary TCI may optimize the system operation in unlicensed spectrum. The use of primary TCI and/or secondary TCI may be adaptive for enhanced performance while reduced signaling overhead. The plurality of TCIs described in terms of primary TCI and/or secondary TCI characterizes a plurality of options to describe the relationship between different signals and/or channels (e.g., the relationship between a source signal and/or channel and a target signal and/or channel; and/or the plurality of TCIs to describe the relationship between a source signal and/or channel and a target signal and/or channel). For example, the plurality of TCIs may also be described as a primary TCI, a secondary TCI, a tertiary TCI, . . . , k^{th} TCI, etc.

In examples, in hierarchical TCIs (e.g., where the TCIs are organized in hierarchy), the hierarchy of TCIs includes a superset of a subset of another hierarchy within the plurality of TCIs. For example, in the case of spatial domain relationship, the plurality of TCIs may be defined according to the granularities (e.g., beam widths) of the beams associated with the target signal and/or channel and the granularities of the beams (e.g., beam width) associated with the source signal and/or channel. For example, for a first level in the hierarchy, the beam associated with a target signal may be a first width beam, and the beam associated with a source signal and/or channel may also be a first width beam. For a second level in the hierarchy, the beam associated with a target signal may be a second width beam, and the beam associated with a source signal and/or channel may also be a second width beam, and so on. It should be noted a first width beam means a beam of a first width, a second width beam means a beam of a second width, and so forth, (e.g. a first TCI, a second TCI, a third TCI, . . . , a k^{th} TCI, etc.).

Hereinafter, the terms primary versus secondary TCI, hierarchical TCIs, or a plurality of TCIs comprising of a first TCI, a second TCI, a third TCI, . . . , a kth TCI, and so on, may be used interchangeably. These interchangeable terms may reference a numbering of a plurality of TCIs that correspond to the plurality of options that could be configured or signaled to described the relationship between a source signal and/or channel, and a target signal and/or channel.

Both primary and secondary TCIs may be carried in the first stage SCI. This solution may increase reception opportunities for Rx WTRU to receive signal and/or channel (e.g., PSSCH). To reduce signaling overhead for the first stage SCI and enable adaptation for TCI to adapt to channel uncertainty, one example considers using 2-stage TCI indication. Primary TCI may be carried in the first stage SCI and secondary TCI(s) may be carried in the second stage SCI. Another example uses TCI bit splitting, wherein TCI bits may be partitioned and/or divided. Some TCI bits may be carried in the first stage SCI. Additional bits for TCI may be carried in the second stage SCI.

An Rx WTRU may use a first TCI to derive a suitable Rx beam for the second stage SCI at Rx WTRU in the Tx WTRU to Rx WTRU sidelink direction. Moreover, an Rx WTRU may derive a suitable Tx beam for the second stage SCI at Tx WTRU in the Tx WTRU to Rx WTRU sidelink direction. An Rx WTRU may use a second TCI to derive a suitable Rx beam for the PSSCH in the Tx WTRU to Rx WTRU sidelink direction. Moreover, an Rx WTRU may derive a suitable Tx beam for the PSSCH in the Tx WTRU to Rx WTRU sidelink direction.

To further optimize the adaptation procedure, the first stage SCI may indicate whether TCI control field is present and/or its location within the second stage SCI. The first stage SCI may also indicate SCI format. For example, an existing SCI format with additional TCI control field(s) and/or a new SCI format which may include a TCI control field may be used. In these examples, one or multiple TCI control fields may be utilized.

For example, a new SCI format for the first stage SCI may be introduced to support TCI for shared spectrum or unlicensed beam-based system. A new SCI format for the second stage SCI may be introduced to support TCI for shared spectrum and/or unlicensed beam-based system.

To support dynamic adaptation of TCI transmission opportunities for shared spectrum, the number of primary and/or secondary TCIs may be based on the number of LBT failures, number of NACKs, ratio of ACKs to NACKs, and/or the like. The number of secondary TCIs may increase if the number of LBT failures increase and/or channel uncertainty is high. The number of secondary TCIs may decrease if the number of LBT failures decreases and/or channel uncertainty is low.

Channel uncertainty may be measured based on, the number of LBT failures, percentage of LBT failures, number of NACKs, percentage of NACKs, ratio of NACKs to ACKs, interference level, and/or the like,

The number of secondary TCIs may be configured, re-configured, dynamically indicated, and/or autonomously increased based on certain condition(s) and/or certain criteria (e.g., a number of secondary TCIs may increase implicitly as LBT failures increase).

Primary TCI and/or secondary TCI signalling may also be based on two stage PC5 RRC and SL MAC CE or three stage PC5 RRC, SL MAC CE, and/or SCI. For example, in the two stages PC5 RRC and SL MAC CE, a Rx WTRU may receive one or more TCIs through PC5 RRC signaling. Subsequently, the Rx WTRU may receive one or more TCIs through MAC CE, wherein the one or more TCIs received through MAC CE is a subset of the one or more TCIs received by the Rx WTRU via PC5 RRC signaling.

In connection with the three stage PC5 RRC, SL MAC CE, and SCI approach to TCI signaling, a Rx WTRU may receive one or more TCIs through PC5 RRC signaling. Subsequently, the Rx WTRU may receive one or more TCIs through MAC CE, wherein the one or more TCIs received through MAC CE is (are) a subset of the one or more TCIs received by the Rx WTRU via PC5 RRC signaling. The Rx WTRU may receive one or more TCIs through SCI, wherein the one or more TCIs received through SCI is a subset of the one or more TCIs received by the Rx WTRU via MAC CE and/or PC5 RRC signaling.

In the two stages PC5 RRC and SL MAC CE, a Tx WTRU may transmit one or more TCIs through PC5 RRC signaling. Subsequently, the Tx WTRU may transmit one or more TCIs through MAC CE, wherein the one or more TCI transmitted through MAC CE is (are) a subset of the one or more TCIs transmitted by the Tx WTRU via PC5 RRC signaling.

In connection with the three stage PC5 RRC, SL MAC CE, and SCI approach to TCI signaling, a Tx WTRU may transmit one or more TCIs through PC5 RRC signaling. Subsequently, the Tx WTRU may transmit one or more TCIs through MAC CE, wherein the one or more TCIs transmitted through MAC CE is (are) a subset of the one or more TCIs transmitted by the Tx WTRU via PC5 RRC signaling. The Tx WTRU may transmit one or more TCIs through SCI, wherein the one or more TCIs transmitted through SCI is (are) a subset of the one or more TCIs transmitted by the Tx WTRU via MAC CE and/or PC5 RRC signaling. The number of TCIs configured, activated and/or indicated may be different between primary and/or secondary TCIs. The examples described above may be applicable to unicast link and extended to multiple unicast links.

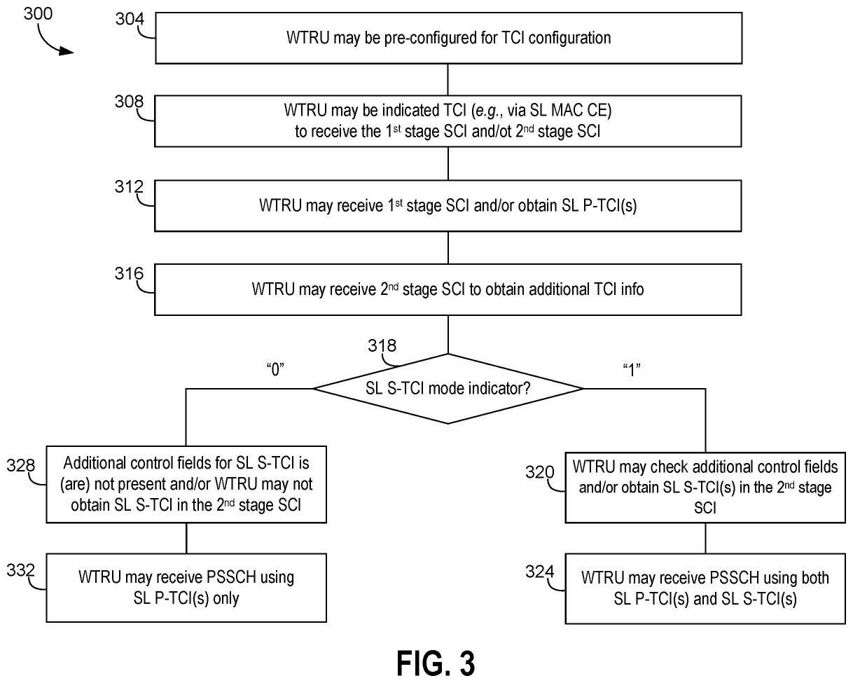

FIG. 3 depicts an example method 300 of sidelink 2-stage SCI based TCI indication. At 304, a WTRU may be pre-configured for TCI configuration. At 308, the WTRU may be indicated for TCI (e.g., via SL MAC CE) to receive the first stage SCI and/or second stage SCI. At 312, the WTRU may receive the first stage SCI using the indicated TCI state(s) (e.g., by SL MAC CE) and obtain information for primary TCI(s) (SL P-TCI(s). At 316, the WTRU may receive second stage SCI to obtain additional TCI information (e.g., secondary SL TCI (SL S-TCI) using the indicated TCI state(s) (e.g., by SL MAC CE). At 318, the WTRU may determine whether the SL S-TCI mode is activated. The value of the SL S-TCI mode indicator may be 1 when the SL S-TCI mode is activated and 0 when the SL S-TCI mode is not activated.

A WTRU may obtain a SL S-TCI mode indicator in the first stage SCI. As shown at 320, if the value of the first stage SCI indicator is “1”, then WTRU may check additional TCI control field(s) and/or obtain SL S-TCI(s) in the second stage SCI. At 324, the WTRU may receive PSSCH using both SL P-TCI(s) and SL S-TCI(s). As shown at 328, if the value of the first stage SCI indicator is “0”, an additional control field for SL S-TCI is not present and/or WTRU may not obtain SL S-TCI in the second stage SCI. At 332, the WTRU may receive PSSCH using SL P-TCI(s) (e.g. only the SL P-TCI(s).

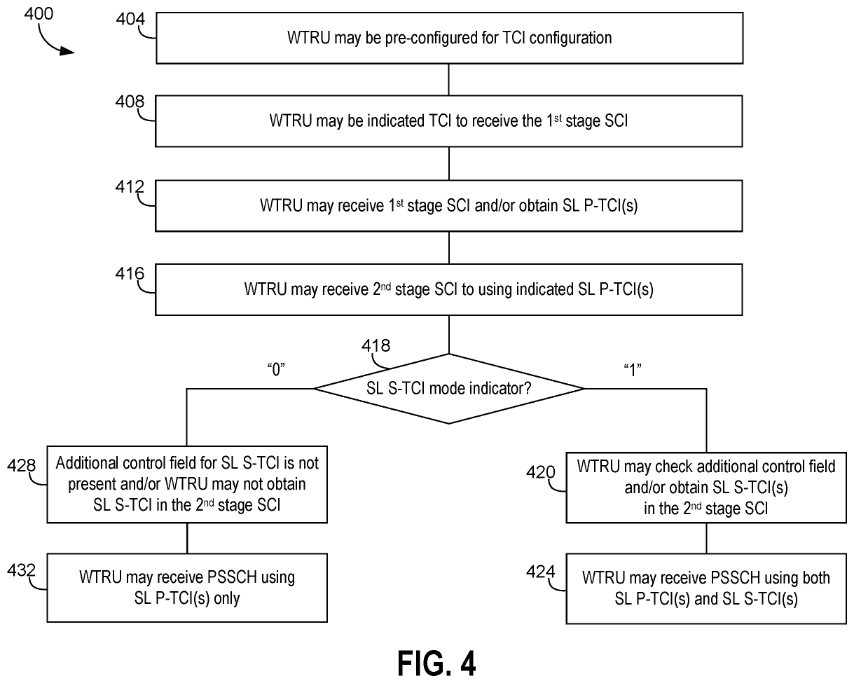

FIG. 4 is another example method of sidelink 2-stage SCI based TCI indication. FIG. 4 depicts the previously described SL P-TCIs and SL S-TCIs which may also be included in the first stage SCI. Additionally or alternatively, both SL P-TCIs and/or SL S-TCIs may also be included in the second stage SCI.

At 404, a WTRU may be pre-configured with TCI configurations and condition(s) for TCI states. At 408 the WTRU may be indicated with TCI to receive the first stage SCI. Such a TCI indication may be via a SL MAC CE. The SL MAC CE may indicate the TCI(s) for Rx WTRU to receive the first stage SCI.

At 412, the WTRU may receive the first stage SCI and/or obtain TCI information such as one or more SL P-TCI(s) to receive the second stage SCI. At 416, the WTRU may receive the second stage SCI using indicated one or more SL P-TCI(s) in the first stage SCI.

The WTRU may obtain TCI information in the second stage SCI to receive PSSCH based on a SL S-TCI mode indicator. The WTRU may receive PSSCH using indicated SL P-TCI in the first stage SCI and/or additionally using indicated SL S-TCI in the second stage SCI. For example, the WTRU may receive data channel using the beam(s) indicated by the SL P-TCI and SL S-TCI(s). For example, the WTRU may receive data channel using the beam indicated by the SL P-TCI and SL S-TCI(s) simultaneously.

The WTRU may check the first stage SCI whether SL S-TCI mode indicator is activated or not. At 418, the WTRU may determine whether the SL S-TCI mode is activated. The value of the SL S-TCI mode indicator may be 1 when the SL S-TCI mode is activated and 0 when the SL S-TCI mode is not activated. At 420, if the SL S-TCI mode is activated and/or indicated, e.g., the SL S-TCI indicator is “1”, then the WTRU may check additional control field and/or obtain SL S-TCI(s) in the second stage SCI. At 424, the WTRU may receive PSSCH using both SL P-TCI(s) and SL S-TCI(s). At 428, if the SL S-TCI mode is not activated and indicated, e.g., the SL S-TCI indicator is “0”, then the additional control field for SL S-TCI is not present. The WTRU may not obtain the SL S-TCI in the second stage SCI. At 432, the WTRU may receive PSSCH using SL P-TCI(s) (e.g., only the SL P-TCI(s).

For fast TCI adaptation, the SL S-TCI mode indicator may be included in the first stage SCI to indicate whether the SL S-TCI control field is present or not. This may reduce overhead while TCI may be changed dynamically. Fast TCI adaptation implies that either TCI states or the number of TCI states may be changed dynamically based on certain criteria and/or channel condition(s). In fast TCI adaptation, TCI states may be adaptive to cope with channel uncertainty. Both TCI states and number of TCI states may be dynamic and/or fast adaptive depending on channel condition(s) and/or channel uncertainty.

In examples, depending on the value of SL S-TCI mode indicator, if the SL S-TCI mode indicator is “1”, then the SL S-TCI control field is present in the second stage SCI. If the SL S-TCI mode indicator is “0”, then the SL S-TCI control field is not present or absent in the second stage SCI.

As described above, the first stage SCI may include both the SL P-TCIs and/or SL S-TCIs. Additionally or alternatively, the second stage SCI may also include both the SL P-TCIs and/or SL S-TCIs. The SL S-TCI mode indicator control field may be fixed and/or not configurable. The SL S-TCI mode indicator control field may always be present in the first stage SCI.

Additionally or alternatively, the SL S-TCI mode indicator control field may be configurable (e.g., by RRC and/or PC5 RRC), For example, PC5 RRC may configure the SL S-TCI mode indicator in the first stage SCI. If configured by RRC, then the SL S-TCI mode indicator control field may be present in the first stage SCI. If not configured by RRC, then the SL S-TCI mode indicator control field may be absent in the first stage SCI.

If configured by RRC and/or PC5 RRC, then the SL S-TCI mode indicator control field may be present. Whether the SL S-TCI control field is present or not may depend on the value of SL S-TCI mode indicator. For example, if the SL S-TCI mode indicator is “1”, then the SL S-TCI control field may be present in the second stage SCI. If the SL S-TCI mode indicator is “0”, then the SL S-TCI control field may not be present and/or absent in the second stage SCI.

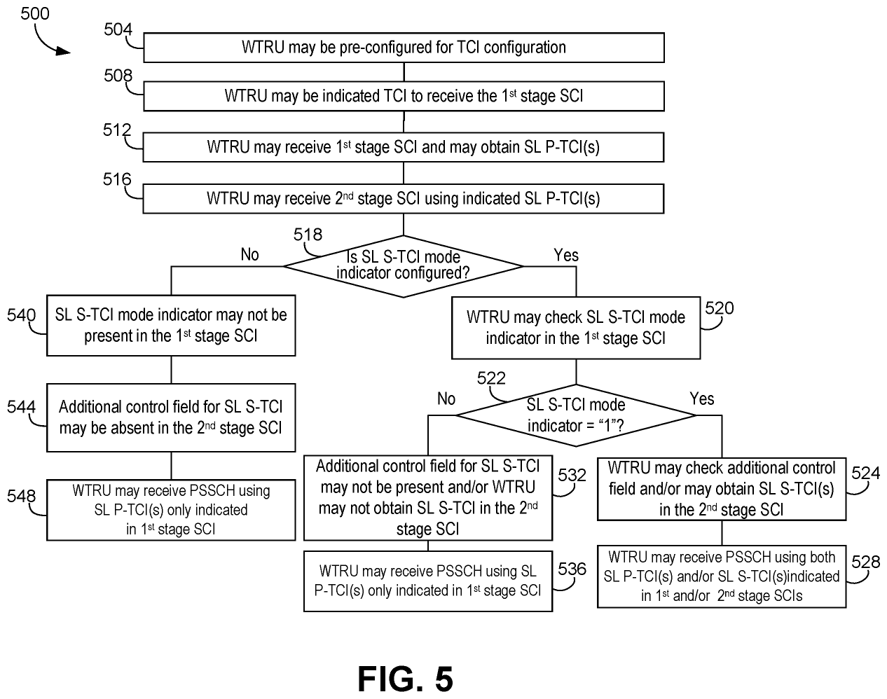

FIG. 5 depicts an example method of sidelink 2-stage SCI based TCI indication with configurable SL S-TCI mode indicator. At 504, the WTRU may be pre-configured with TCI configurations. At 508, the WTRU may be indicated for a TCI to receive the first stage SCI. A SL MAC CE may indicate the TCI(s) for Rx WTRU to receive the first stage SCI. At 512, a WTRU may receive the first stage SCI and/or obtain TCI information such as one or more SL P-TCI(s) to receive the second stage SCI. At 516, the WTRU may receive the second stage SCI using indicated one or more SL P-TCI(s) in the first stage SCI.

A WTRU may obtain TCI information in the second stage SCI to receive PSSCH based on SL S-TCI mode indicator. The WTRU may receive a PSSCH using indicated SL P-TCI in the first stage SCI and/or additionally using indicated SL S-TCI in the second stage SCI.

At 518, the WTRU may determine whether the SL S-TCI mode indicator is activated and/or configured. For example, the WTRU may check, at 518, the first stage SCI to determine whether the SL S-TCI mode indicator is configured or not. If the SL S-TCI mode is configured, then the WTRU may check, at 520, the value of SL S-TCI mode indicator in the first stage SCI. The value of the SL S-TCI mode indicator may be 1 when the SL S-TCI mode is activated and 0 when the SL S-TCI mode is not activated. At 522, the WTRU may determine whether the S-CI mode indicator is set to 1. At 524, if the value of the SL S-TCI mode indicator is “1” or “on”, then the WTRU may check additional control field and/or may obtain the SL S-TCI(s) in the second stage SCI. At 528, the WTRU may receive PSSCH using both SL P-TCI(s) and SL S-TCI(s) indicated in the first and/or second stage SCIs. At 532, if the value of the SL S-TCI mode indicator is “0” or “off”, then the additional control field for SL S-TCI may not be present and/or the WTRU may not obtain the SL S-TCI in the second stage SCI. At 536, the WTRU may receive PSSCH using SL P-TCI(s) (e.g., only the SL P-TCI(s) indicated in the first stage SCI.

At 540, if the SL S-TCI mode is not configured, then the SL S-TCI mode indicator may not present in the first stage SCI. At 544, an additional control field for the SL S-TCI may be absent in the second stage SCI. The WTRU may not obtain SL S-TCI(s) in the second stage SCI. At 548, the WTRU may receive a PSSCH using SL P-TCI(s) (e.g., only the SL P-TCI(s) only indicated in the first stage SCI.

If the SL S-TCI mode indicator is “1,” then the SL S-TCI control field is present in the second stage SCI. If the SL S-TCI mode indicator is “0,” then the SL S-TCI control field is not present or absent in the second stage SCI.

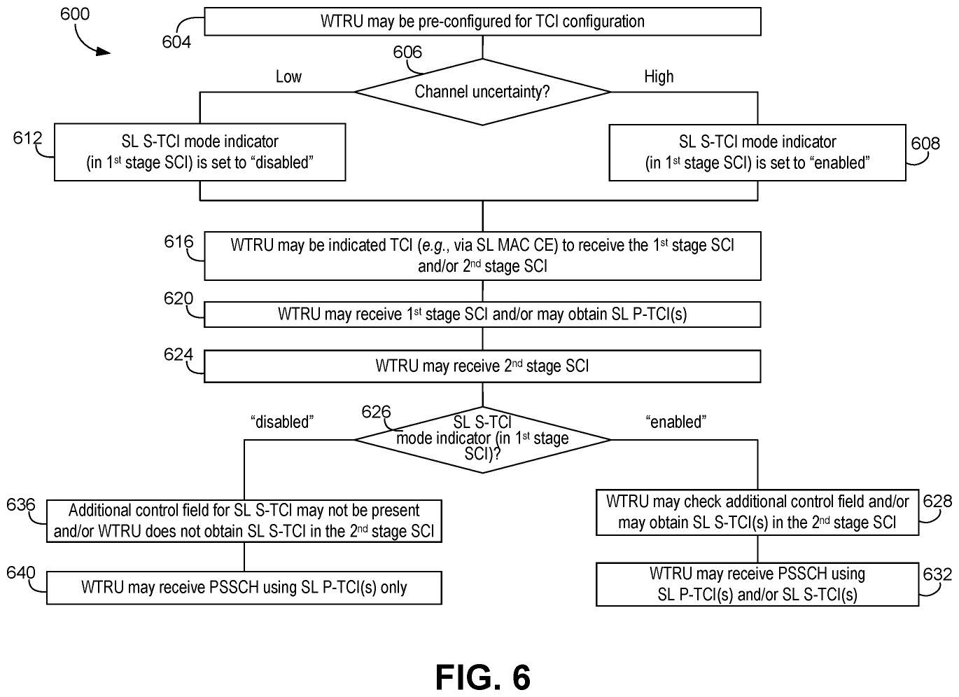

FIG. 6 depicts an example method 600 of TCI adaptation. A fast TCI adaptation procedure may be enabled and/or achieved using the SL S-TCI mode indicator. The criteria for fast TCI adaptation may be based on channel condition(s) and/or degrees of channel uncertainty.

At 604, a WTRU may be pre-configured for TCI configuration. At 606, the WTRU may determine a channel uncertainty. Depending on channel uncertainty, the SL S-TCI mode indicator may be set properly. At 608, if the channel uncertainty is high, then the SL S-TCI mode indicator in the first stage SCI may be set to “enabled.” At 612, if the channel uncertainty is low, then the SL S-TCI mode indicator in the first stage SCI may be set to “disabled.”

At 616, a WTRU may be indicated TCI (e.g., via SL MAC CE) to receive the first stage SCI and/or the second stage SCI. At 620, the WTRU may receive the first stage SCI and obtain SL P-TCI(s). A1 624, the WTRU may receive the second stage SCI.

At 626, the WTRU may determine whether the SL S-TCI mode indicator is enabled, for example, in the first stage SCI. At 628, if the SL S-TCI mode indicator in the first stage SCI indicates “enabled”, then WTRU may check additional control field and/or obtain additional TCIs (e.g., SL S-TCI(s) in the second stage SCI. At 632, the WTRU may receive PSSCH using both SL P-TCI(s) and/or SL S-TCI(s), At 636, if the SL S-TCI mode indicator in the first stage SCI indicates “disabled,” then the additional control field for the SL S-TCI may not be present and the WTRU may not obtain SL S-TCI in the second stage SCI. At 640, the WTRU may receive a PSSCH using SL P-TCI(s) (e.g. only the SL. P-TCI(s).

In a slot, 7 to 14 SL symbols may be pre-configured. A PSSCH may be sent in 5 to 12 consecutive SL symbols. The number of PSSCH symbols may depend on the number of SL symbols in a slot and/or whether PSFCH may be sent in the slot. In the 2 or 3 SL symbols which carry a PSCCH, the PSSCH may be multiplexed with the PSCCH. If the PSCCH does not span the entire L_PSSCH sub-channels, the PSSCH may be multiplexed with a PSCCH in the frequency domain. Each PSSCH sub-channel may consist of one or multiple physical resource blocks (PRBs). L-PSSCH sub-channels may have L sub-channels wherein L may be one or greater than one. This may result in 2 or 3 PSCCH/PSSCH symbols. If the PSCCH spans the entire L_PSSCH sub-channels, the PSSCH may be multiplexed with PSCCH in the time domain. In the SL symbols without PSCCH, the PSSCH spans all the L_PSSCH sub-channels. In examples, if the PSCCH does not span the entire L_PSSCH sub-channels, the PSSCH may be multiplexed with PSCCH in the frequency domain.

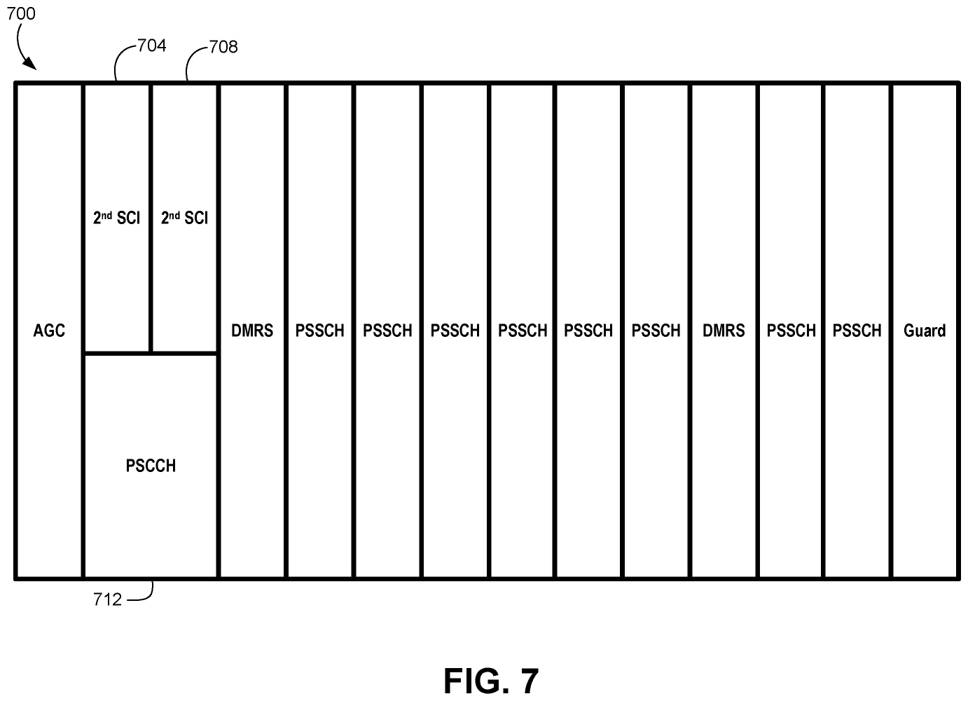

FIG. 7 is an example scenario 700 for physical sidelink shared channel (PSSCH) multiplexed with second SCI in frequency domain and second SCI multiplexed with PSSCH in time domain. As depicted in FIG. 7, the second stage SCI 704, 708 may be multiplexed with PSCCH 712 in the second and third OFDM symbols in the frequency domain. Here, the SCI may be multiplexed with a PSSCH in the time domain. One beam, TCI, one set of beams, and/or one set of TCIs (e.g., wide beam(s) and/or primary beam(s) may be used for both the PSCCH and/or the second stage SCI. Another beam, TCI, another set of beams and/or another set of TCIs (e.g., narrow beam(s) and/or primary and/or secondary beams) may be used for the PSSCH. In this configuration, the example method described in FIG. 3 may be applied. In examples, at the same beam, TCI, set of beams, and/or set of TCIs may be used for the PSCCH and/or second stage SCI. Additionally or alternatively, the same beam, TCI, set of beams, and/or set of TCIs may be used for the PSCCH, the second stage SCI and/or the PSSCH.

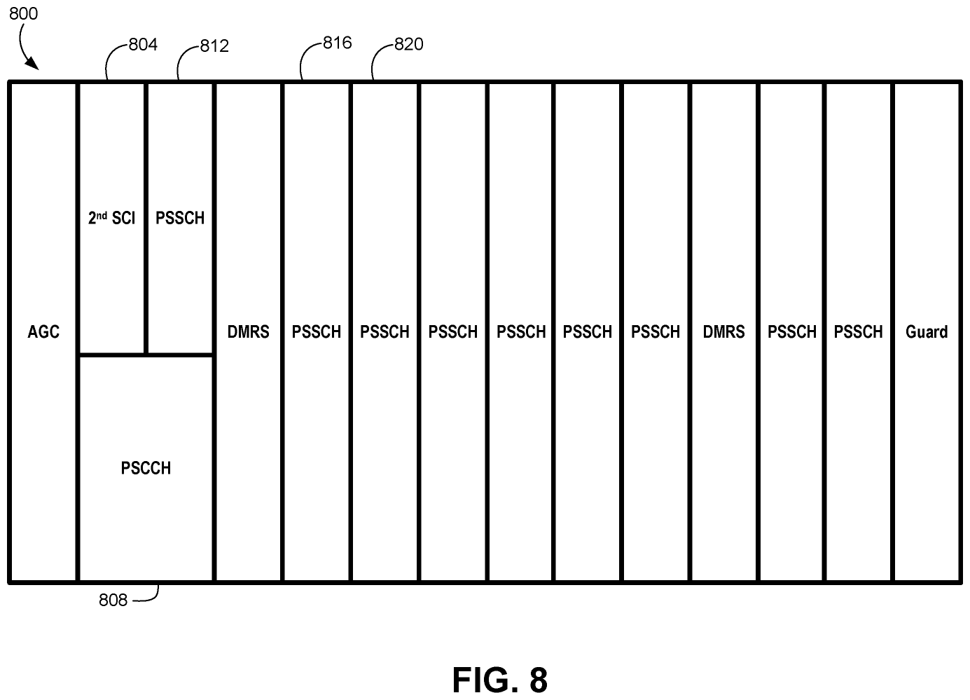

FIG. 8 is another example scenario 800 for PSSCH multiplexed with second SCI in frequency domain and second SCI multiplexed with PSSCH in time domain. As depicted in FIG. 8, the second stage SCI 804 may be multiplexed with a PSCCH 808 and/or a PSSCH 812 in the second and third OFDM symbols in the frequency/time domain. The second stage SCI may be multiplexed with the PSSCH 816, 820 in the fifth and sixth OFDM symbols and subsequent OFDM symbols in the time domain. One beam, TCI, one set of beams, and/or one set of TCIs (e.g., wide beam(s) and/or primary beam(s) may be used for the PSCCH, the second stage SCI and/or the PSSCH multiplexed with PSCCH in frequency domain. Another beam, TCI, another set of beams, and/or another set of TCIs (e.g., narrow beam(s) or primary and/or secondary beams) may be used for other PSSCHs multiplexed with the PSCCH in the time domain. The example method described in FIG. 3 may be applied. In examples, the same beam, TCI, set of beams, and/or set of TCIs may be used for a PSCCH and/or the second stage SCI. Additionally or alternatively, the same beam, TCI, set of beams, and/or set of TCIs may be used for the PSCCH, the second stage SCI, and/or the PSSCH.

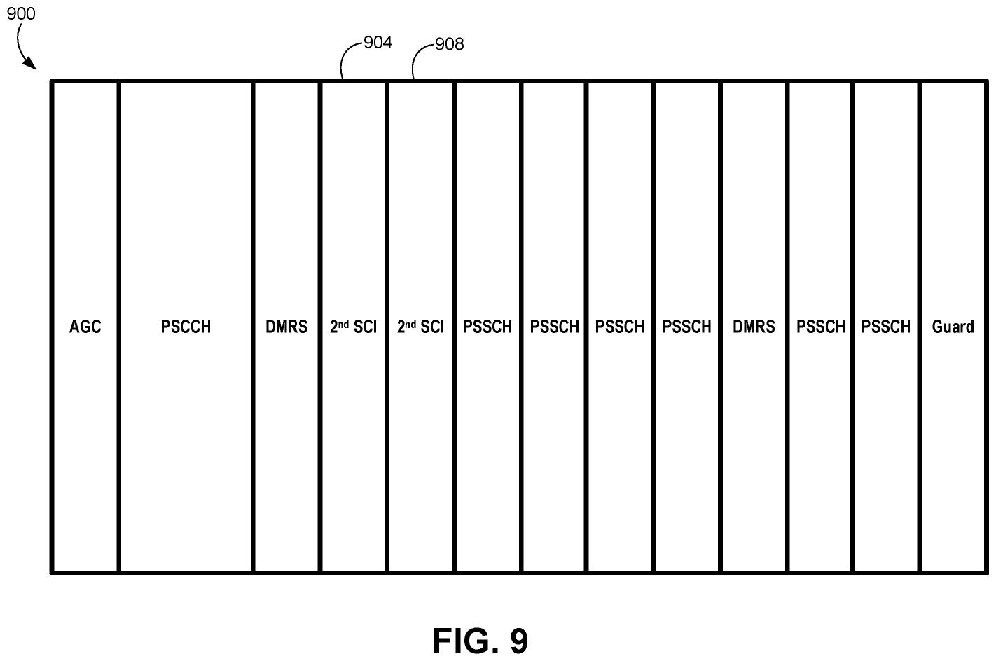

FIG. 9 depicts an example scenario 900 for second SCI multiplexed with PSSCH in time domain. Moreover, FIG. 9 depicts an example wherein when the PSCCH spans the entire L_PSSCH sub-channels, the PSSCH may be multiplexed with PSCCH in the time domain. The second stage SCI may not be multiplexed with a PSSCH in the frequency domain. Instead, the second stage SCI may be time multiplexed with the PSSCH 904, 908 in the fifth and sixth OFDM symbols. The second stage SCI may be multiplexed with a PSSCH in the time domain. One beam and/or TCI (e.g., wide beam) may be used for the PSCCH; another beam and/or TCI (e.g., wide beam and/or primary beam) may be used for the second stage SCI, and/or another beam and/or TCI (e.g., narrow beam or primary and/or secondary beam) may be used for the PSSCH. The example method described in FIG. 4 may be applied. The same beam, TCI, set of beams, and/or set of TCIs may be used for the PSCCH and/or second stage SCI. Additionally or alternatively, the same beam, TCI, set of beams, and/or set of TCIs may be used for the PSCCH, the second stage SCI, and/or the PSSCH.

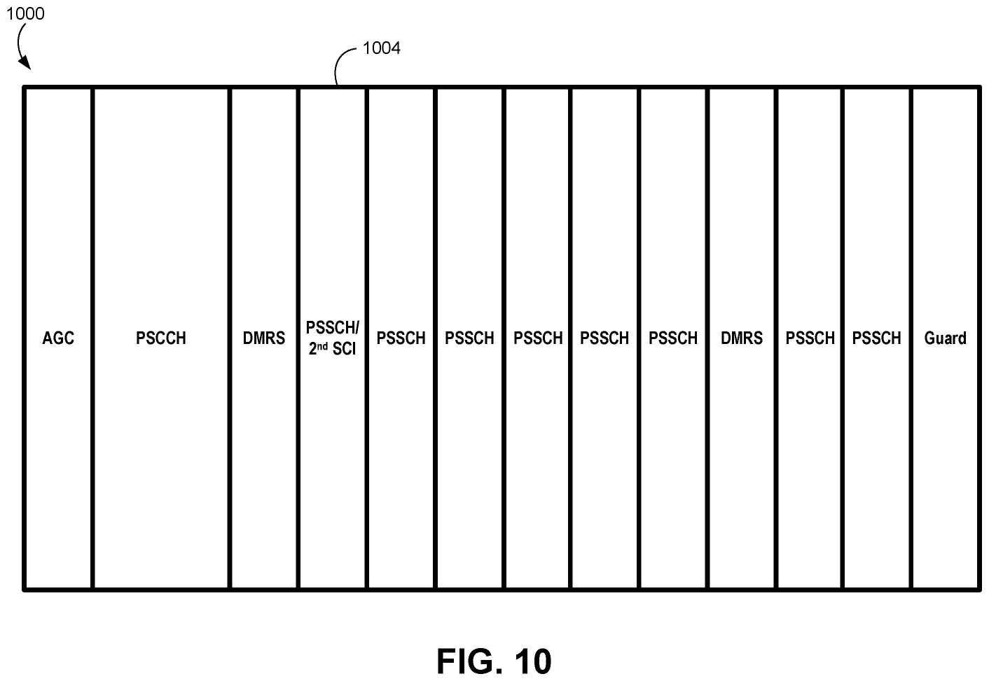

FIG. 10 depicts an example scenario 1000 for second SCI multiplexed with PSSCH in frequency domain. As shown in FIG. 10, another example includes the second stage SCI 1000 may be multiplexed with a PSSCH in the frequency domain in the fifth OFDM symbol. The second stage SCI may be multiplexed with PSSCH in the time domain for other OFDM symbols. One beam and/or TCI (e.g., wide beam) may be used for the PSCCH; another beam and/or TCI (e.g., wide beam and/or primary beam) may be used for the second stage SCI and/or some PSSCH; and another beam and/or TCI (e.g., narrow beam and/or primary and/or secondary beam) may be used for other PSSCHs not frequency multiplexed with the SCI. The example method described in FIG. 4 may be applied.

The same beam, TCI, set of beams, and/or set of TCIs may be used for the PSCCH and/or second stage SCI. Additionally or alternatively the same beam, TCI, set of beams, and/or set of TCIs may be used for the PSCCH, the second stage SCI, and/or the PSSCH. Additionally or alternatively, a WTRU may receive a PSSCH and the second stage SCI using the same beam, TCI, set of beams, and/or set of TCIs if they are multiplexed in frequency domain. The WTRU may receive the PSSCH and the second stage SCI using different beams, TCIs, sets of beams, and/or sets of TCIs simultaneously if they are multiplexed in frequency domain. The WTRU may receive the PSSCH and/or the second stage SCI using different beams, TCIs, set of beams, and/or set of TCIs in parallel, depending on the WTRU's capability.

The beam and/or TCI used for the PSCCH, the second stage SCI, and the PSSCHs may be the same type or different type (e.g., primary and/or secondary beam or TCI), and may be the same beam and/or different beam, and may employ same number or different number of beams. This configuration may be based on e.g., channel condition(s) and/or channel uncertainty, or the like. The operation may be adaptive to dynamically cope with changing channels, channel uncertainty, and/or interference.

When a TCI and/or a set of TCIs are indicated, and if the switch timeline is below a predefined or pre-configured threshold, then the indicated TCI and/or the set of TCIs may be applied. If the timeline is not below or above a predefined and/or pre-configured threshold, then the indicated TCI and/or the set of TCIs may not be applied. A default TCI and/or a default set of TCIs may be applied instead. The default TCI and/or the default set of TCIs may be configured, pre-configured, and/or predefined.

In examples, channel uncertainty (CU) may be based on a plurality of factors, including but not limited to: a number of LBT failures, ratio of LBT failures to total measurements, ratio of LBT failures to successes, NACK to ACK ratio, percentage of NACKs, CBR, Interference level, and/or combination of them.

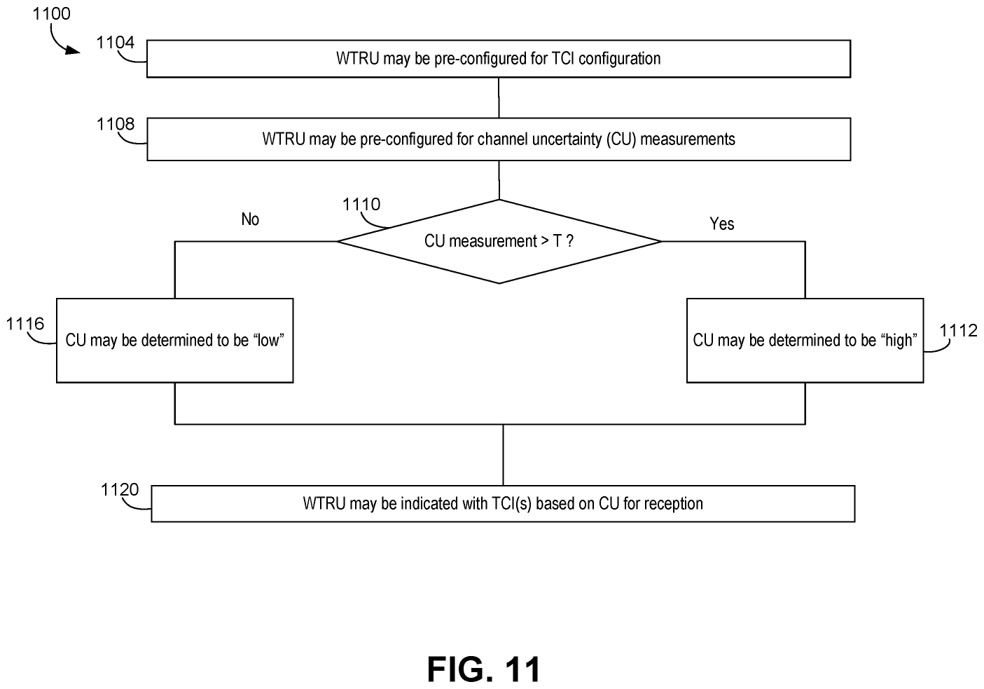

FIG. 11 depicts an example method 1100 of channel uncertainty determination. At 1004, a WTRU may be pre-configured for TCI configuration. At 1108, the WTRU may be pre-configured for CU measurements. At 1110, the WTRU may determine whether a CU measurement is greater than a threshold value T. At 1112, if the CU measurement is greater than the threshold T, then channel uncertainty may be determined to be “high.” At 1116, If the CU measurement is equal to T or less than T, then channel uncertainty may be determined to be “low.” At 11120, the WTRU may be indicated with the TCI(s) determined based on channel uncertainty for reception. A CU measurement may include: a number of LBT failures, ratio of LBT failures to total measurements, ratio of LBT failures to successes, NACK to ACK ratio, percentage of NACKs, CBR, interference level, and/or the like.

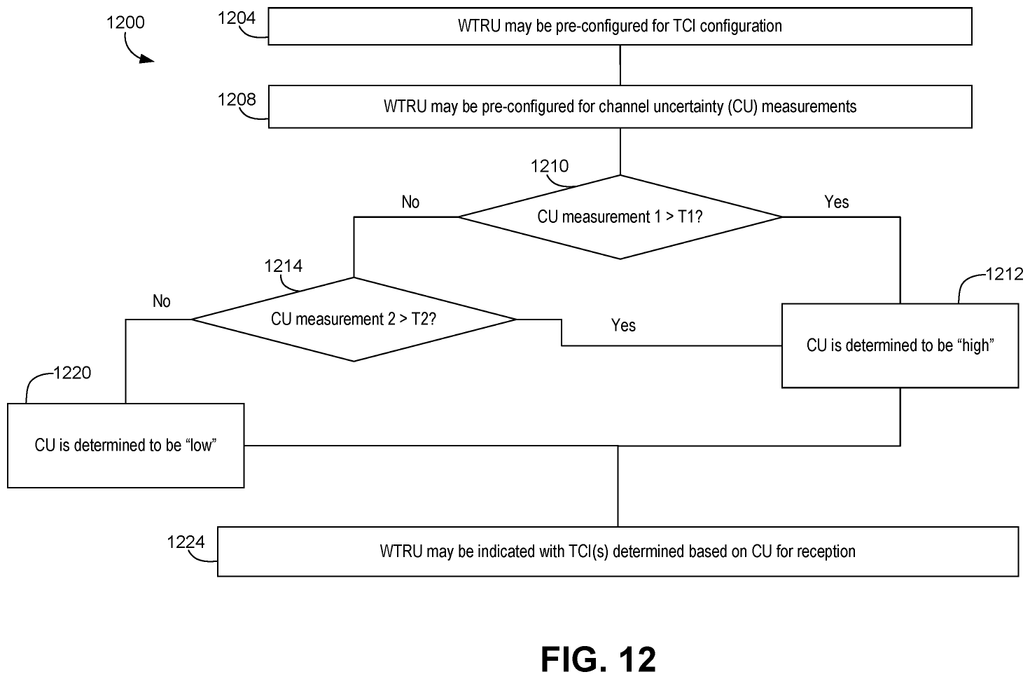

FIG. 12 depicts another example method 1200 of channel uncertainty determination. At 1204, a WTRU may be pre-configured for TCI configuration. At 1208, the WTRU may be pre-configured for CU measurements. At 1210, the WTRU may determine whether a first CU measurement is greater than a first threshold value T1. At 1212, if a first CU measurement 1 is greater than a first threshold T1, then the CU is determined to be “high.” If the first CU measurement 1 is not greater than the first threshold T1, then a second CU measurement 2 may be further checked. At 1214, the WTRU may determine whether the second CU measurement is greater than a second threshold value T2. At 1212, if the first CU measurement 1 is greater than the second threshold T2, then the CU is determined to be “high.” At 1220, if the first CU measurement 1 is equal to T2 or less than T2, then the CU is determined to be “low.” At 1224, the WTRU may be indicated with TCI(s) determined based on channel uncertainty for reception. The first CU measurement 1 and the second CU measurement 2 may include: a number of LBT failures, ratio of LBT failures to total measurements, ratio of LBT failures to successes, NACK to ACK ratio, percentage of NACKs, CBR, interference level, and/or the like.

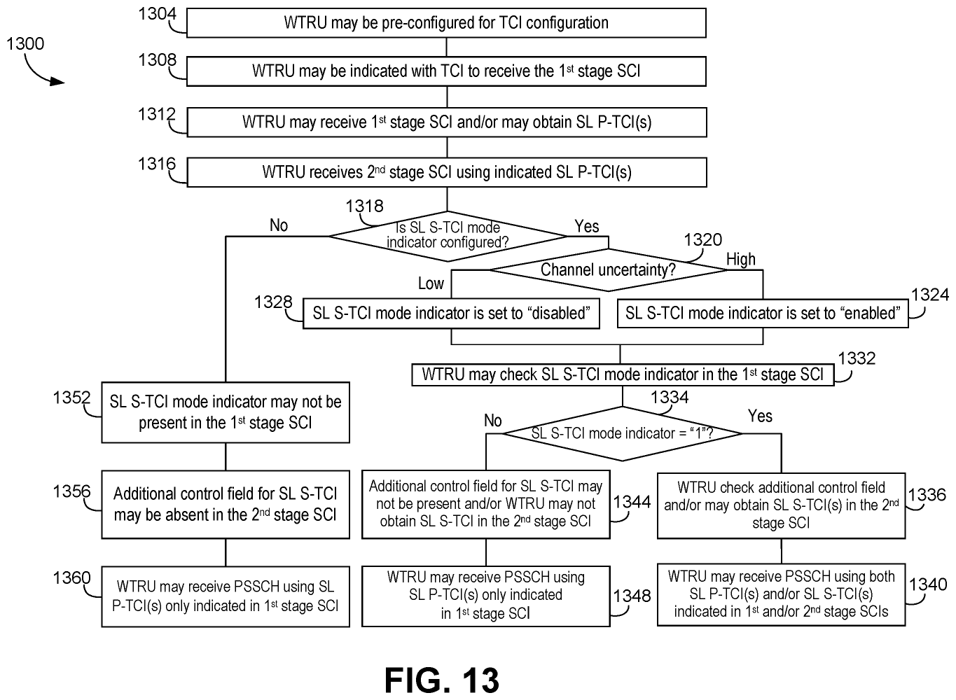

FIG. 13 depicts an example method 1300 of TCI adaptation. At 1304, a WTRU may be pre-configured for TCI configuration. Depending on CU, the SL S-TCI mode indicator may be set properly. At 1308, the WTRU may be indicated with TCI to receive the first stage SCI. At 1312, the WTRU may receive the first stage SCI and/or obtain SL P-TCI(s). At 1316, the WTRU may receive second stage SCI using indicated SL P-TCI(s).

At 1318, the WTRU may determine whether the SL S-TCI mode indicator is configured. At 1320, if the TCI mode indicator is configured, the WTRU may further check the CU. For example, the WTRU may determine, at 1320, the CU (e.g., whether the CU is low or high). At 1324, If the CU is high, then the SL S-TCI mode indicator in the first stage SCI may be set to “enabled.” At 1328, if the CU is low, then the SL S-TCI mode indicator in the first stage SCI may be set to “disabled.” The WTRU may be indicated with TCI to receive the first stage SCI. The WTRU may receive the first stage SCI and obtain SL P-TCI(s). The WTRU may receive second stage SCI using indicated SL P-TCI(s). If the SL S-TCI mode indicator is configured, then the WTRU may further check the CU. If the CU is high, then the SL S-TCI mode indicator may be set to “enabled.” If the CU is low, then the SL S-TCI mode indicator may be set to “disabled.” The WTRU may receive the second stage SCI.

At 1332, when the WTRU receives the first stage SCI, the WTRU may check the SL S-TCI mode indicator in the control field of the first stage SCI. At 1334, the WTRU may determine whether the SL S-TCI mode indicator is equal to 1. When the SL S-TCI mode indicator is equal to 1, the SL S-TCI mode may be enabled. When the SL S-TCI mode indicator is equal to 0, the SL S-TCI mode may be disabled. At 1336, if the SL S-TCI mode indicator in the first stage SCI indicates “enabled,” then the WTRU may check additional control field and/or obtain additional TCIs (e.g., SL S-TCI(s) in the second stage SCI. At 1340, the WTRU may receive a PSSCH using both the SL P-TCI(s) and SL S-TCI(s) indicated in the first stage SCI and/or second stage SCI.

At 1344, if the SL S-TCI mode indicator in the first stage SCI indicates “disabled,” then an additional control field for the SL S-TCI may not be present and/or the WTRU may not obtain SL S-TCI in the second stage SCI. At 1348, the WTRU may receive a PSSCH using SL P-TCI(s) (e.g., only the SL P-TCI(s)).

If the SL S-TCI mode indicator is not configured, then the WTRU may not check the CU. At 1362, the SL S-TCI mode indicator may not be present in the first stage SCI. At 1356, an additional control field for SL S-TCI may not be present and/or the WTRU may not obtain the SL S-TCI in the second stage SCI. At 1360, the WTRU may receive PSSCH using SL P-TCI(s) (e.g., only the SL P-TCI(s) only indicated in the first stage SCI.

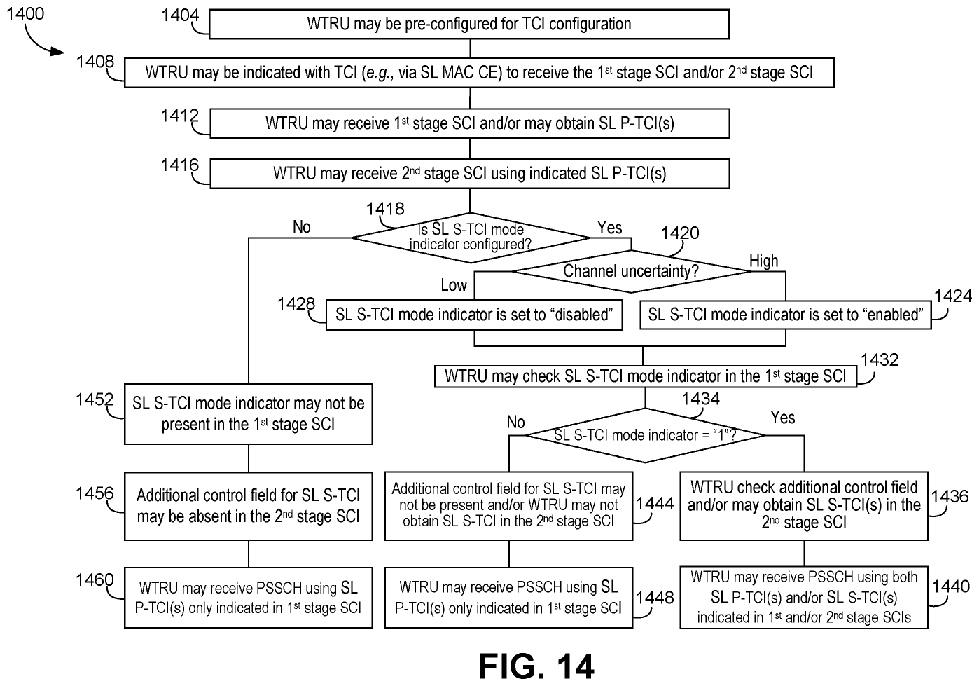

FIG. 14 depicts another example method 1400 of TCI adaptation. At 1404, the WTRU may be pre-configured for TCI configuration. Depending on the CU, the SL S-TCI mode indicator may be set properly. If the CU is high, then SL S-TCI mode indicator in the first stage SCI may be set to “enabled.” If the CU is low, then the SL S-TCI mode indicator in the first stage SCI may be set to “disabled.” At 1408, the WTRU may be indicated with TCI (e.g., via sidelink medium access control control element (SL MAC CE) to receive the first stage SCI and/or the second stage SCI. At 1412, the WTRU may receive the first stage SCI and/or may obtain SL P-TCI(s).

At 1418, the WTRU may determine whether the SL S-TCI mode indicator is configured. At 1420, if the SL S-TCI mode indicator is configured, then the WTRU may further check the CU. For example, the WTRU may determine, at 1420, the CU (e.g., whether the CU is low or high). The WTRU may be configured to determine whether to disable the SL S-TCI mode indicator (e.g., for a second stage SCI) based on the CU. At 1424, if the CU is determined to be high, the WTRU may enable the SL S-TCI mode indicator (e.g., the SL S-TCI mode indicator may be set to “enabled”). At 1428, if the CU is determined to be low, the WTRU may disable the SL S-TCI mode indicator (e.g., the SL S-TCI mode indicator may be set to “disabled”).

At 1432, a WTRU may receive the second stage SCI to obtain additional TCI information. At 1434, the WTRU may determine whether the SL S-TCI mode indicator is equal to 1. When the SL S-TCI mode indicator is equal to 1, the SL S-TCI mode may be enabled. When the SL S-TCI mode indicator is equal to 0, the SL S-TCI mode may be disabled. At 1436, if the SL S-TCI mode indicator in the first stage SCI indicates “enabled,” then the WTRU may check additional control field and obtain additional TCIs (e.g., SL S-TCI(s) in the second stage SCI. At 1440, the WTRU may receive a PSSCH using both the SL P-TCI(s) and/or SL S-TCI(s), When the WTRU receives the first stage SCI, the WTRU may check the SL S-TCI mode indicator in control field of the first stage SCI.

At 1444, if the SL S-TCI mode indicator in the first stage SCI indicates “disabled”, then the additional control field for SL S-TCI may not be present and/or the WTRU may not obtain SL S-TCI in the second stage SCI. At 1448, the WTRU may receive a PSSCH using SL P-TCI(s) (e.g., only the SL P-TCI(s).

If the SL S-TCI mode indicator is not configured, then the WTRU may not check the CU. At 1452, the SL S-TCI mode indicator may not be present in the first stage SCI. At 1456, an additional control field for the SL S-TCI may not be present and/or the WTRU may not obtain the SL S-TCI in the second stage SCI. At 1460, the WTRU may receive a PSSCH using SL P-TCI(s) (e.g., only the SL P-TCI(s) only indicated in the first stage SCI.

A WTRU may learn about one or more SL TCI(s) for the reception and/or transmission of a first stage SCI and/or the reception and/or transmission of a second stage SCI. For example, SL TCI(s) for a first stage SCI and/or a second stage SCI may be configured and/or pre-configured for the WTRU.

In examples, configuration and/or pre-configuration may be coupled with activation and/or indication. For example, for a two-stage configuration scheme, wherein the first stage the WTRU may first receive configuration parameters and/or a set of configuration parameters. The WTRU may receive the configuration parameters and/or a set of configuration parameters through pre-configuration and/or semi-static configuration signaling such as RRC signaling. In the second stage, the WTRU may receive an activation command in the form of a SL MAC CE or SCI instructing the WTRU of which of the one or more configuration parameters and/or subsets of the configuration parameters received in first stage to use.

TCI(s) for the first stage SCI and/or the second stage SCI may be separately pre-configured into the WTRU. For example, a first SL TCI may be pre-configured into the WTRU for the first stage SCI, and a second TCI may be pre-configured into the WTRU for the second stage SCI. The WTRU may use the first TCI to derive a suitable beam for the reception of the first stage SCI. The WTRU may use the second TCI to derive a suitable beam for the reception of the second stage SCI.

TCI(s) for the first stage SCI and/or second stage SCI may be jointly pre-configured into the WTRU. For example, a joint TCI may be configured into the WTRU. The WTRU may use the joint TCI to derive a suitable beam for the reception of the first stage SCI. The WTRU may use the joint TCI to derive a suitable beam for the reception of the second stage SCI.

The SL TCI(s) for the first stage SCI may be pre-configured into the WTRU, herein referred to as first TCI(s). The WTRU uses the first TCI for the first stage SCI to derive a second TCI for the second stage SCI. In examples, the first TCI and/or the second TCI may be separate TCIs. The WTRU may use the first TCI to derive a suitable beam for the reception of the first stage SCI. The WTRU may use the second TCI to derive a suitable beam for the reception of the first second stage SCI. In examples, the first TCI and/or the second TCI may be a joint TCI. The WTRU may use the joint TCI to derive a suitable beam for the reception of the first stage SCI and/or a suitable beam for the reception of the second stage SCI.

The SL TCI(s) for first stage SCI and/or second stage SCI may be activated into the WTRU. TCI(s) for first stage SCI and/or second stage SCI may be separately activated into the WTRU. For example, a first SL TCI may be activated into the WTRU for the first stage SCI, and/or a second TCI may be activated into the WTRU for the second stage SCI. The WTRU may use the first TCI to derive a suitable beam for the reception of the first stage SCI. The WTRU may use the second TCI to derive a suitable beam for the reception of the first second stage SCI.

TCI(s) for first stage SCI and second stage SCI may be jointly activated into the WTRU. For example, a joint TCI may be activated into the WTRU. The WTRU may then use the joint TCI to derive a suitable beam for the reception of the first stage SCI and/or a suitable beam for the reception of the second stage SCI.

The SL TCI(s) for the first stage SCI may be activated into the WTRU, herein referred to as first TCI(s). The WTRU may use the first TCI for the first stage SCI to derive a second TCI for the second stage SCI. For example, the first TCI and/or the second TCI may be separate TCIs. The WTRU may use the first TCI to derive a suitable beam for the reception of the first stage SCI. The WTRU may use the second TCI to derive a suitable beam for the reception of the first second stage SCI. In examples, the first TCI and/or the second TCI may be a joint TCI. The WTRU may use the joint TCI to derive a suitable beam for the reception of the first stage SCI, and/or a suitable beam for the reception of the second stage SCI.

Both the two stage PC5 RRC and SL MAC CE and/or the three stag PC5 RRC, SL MAC CE, and SCI as a signaling approach to configuration and/or activation of TCIs for WTRU also apply to the TCIs for the first stage SCI and/or the second stage SCI as described above. In two stage SL TCI indication, PC5 RRC may be used to configure a set of SL TCI states. SL MAC CE may be used to indicate the exact SL TCI state(s) among the configured set of SL TCI states for the WTRU. In three stage SL TCI indication, PC5 RRC may be used to configure SL TCI states. SL MAC CE may be used to activate a subset of SL TCI states among the configured set of SL TCI states. SCI (e.g., the first stage SCI and the second stage SCI) may be used to indicate the exact SL TCI state(s) among the activated subset of SL TCI states for the WTRU.

The two stage and/or three stage SL TCI indication may be used to indicate SL TCI state(s) for SL data channel (e.g., PSSCH). Two stage and/or three stage SL TCI indication may also be used to indicate SL TCI state(s) for SL control channel (e.g., PSCCH). In addition such two stage and/or three stage, SL TCI indication may also be used for same carrier scheduling and/or cross carrier scheduling. Further, two stage and/or three stage SL TCI indication may be used for the same slot scheduling and/or cross slot scheduling.

Hereinafter, the term SL TCI state and/or TCI state may be used as a configuration element and/or information element (e.g. one or more of SL TCI-State or SL TCI-State-r18, SL TCI-State-r19 or SL TCI-State-r20, RS, and/or corresponding quasi co-location (QCL) type(s), etc.). One or more TCI may be determined and/or derived from a TCI state. For example, a TCI in the transmission direction of a first WTRU, hereinafter referred to by the term WTRU1, to a second WTRU, hereinafter referred to by the term WTRU2, or in the transmission direction of the WTRU2 to WTRU1, may be determined from a TCI state.

The term SL TCI codepoint may be used herein as an allowed value of a SL TCI field in a DCI and/or in a SCI. A SL TCI codepoint may map to one or more SL TCI states (e.g., multiple SL TCI states used for either TCI for WTRU1 to WTRU2 transmission direction; TCI for WTRU2 to WTRU transmission direction; one SL TCI state used for TCI for WTRU1 to WTRU2 transmission direction; and/or one TCI state used for TCI for WTRU2 to WTRU1 transmission direction). A SL TCI codepoint may map to one or more SL TCI(s) (e.g. one TCI for WTRU1 to WTRU2 transmission direction and one TCI for WTRU2 to WTRU1 transmission direction). A TCI state may correspond to one or more TCIs.

Both the TCI for the WTRU2 to WTRU1 transmission direction and the TCI for WTRU1 to WTRU2 transmission direction may be derived from the same TCI state. For example, the WTRU2 may use the same SL RS to determine the WTRU2 Rx beam; the WTRU1 Tx beam for the WTRU1 to WTRU2 transmission direction; and/or determine the WTRU2 Tx beam for the WTRU2 to WTRU1 transmission direction. In this case, a joint pool (e.g., set) of TCI states may be configured for both the WTRU1 to WTRU2 transmission direction as well as the WTRU2 to WTRU1 transmission direction.

Separate pools (e.g., sets) of TCI states may be configured (e.g., one pool of TCI states for the transmission direction of WTRU1 to WTRU2 and another pool of TCI states for the transmission direction of WTRU2 to WTRU1). For example, a first SL RS may be used to determine the WTRU2 Rx beam or WTRU1 Tx beam for the WTRU1 to WTRU2 transmission direction, while a second SL RS may be used to determine the WTRU2 Tx beam for the WTRU2 to WTRU1 transmission direction.

The TCI may be configured into the Rx WTRU and/or the Tx WTRU at a plurality of granularity levels (e.g., per component carrier (CC), per bandwidth part (BWP), per control resource set (CORESET), per reference signal (RS) type, per Rx WTRU (for e.g. from the perspective of a Tx WTRU), per Tx WTRU (e.g., from the perspective of a Rx WTRU), per pair Tx and/or Rx WTRU, per sidelink link ID, per Service or per destination L2 ID, per pair of source L2 ID and destination L2 ID, per source L2 ID, per RS type, per channel (e.g. PSBCH), PSCCH, PSSCH, PSFCH), and/or per resource pool).

The source or target RS types may include a SLSS (e.g., S-SSB), SL CSI-RS, SL PT-RS, DMRS for PSCCH and/or DMRS for a PSSCH. The sources and/or target channels may include PSBCH, PSCCH, PSSCH, and/or PSFCH.

A plurality of QCL types may be considered on sidelink, including, e.g., QCL-TypeA (e.g. Doppler shift, Doppler spread, average delay, delay spread), QCL-TypeB (e.g. Doppler shift, Doppler spread), QCL-TypeC (e.g. Doppler shift, average delay), and/or QCL-TypeD (e.g. Spatial Rx parameter).

One or more of a plurality of nodes may transmit a source RS. Such nodes include: . a Tx WTRU (a helper and/or an assisting node of a Tx WTRU). The Tx WTRU may transmit source RS to the Rx WTRU with or without assistance from an Rx WTRU (e.g., a helper or an assisting node of the Tx WTRU). Such nodes may further include a Rx WTRU (e.g., a helper and/or an assisting node of a Rx WTRU). The Rx WTRU may transmit source RS to the Tx WTRU (e.g., in support of HAR feedback over a PSFCH) with or without assistance from the Tx WTRU (e.g., a helper and/or an assisting node of a Rx WTRU.

One or more of a plurality of nodes might configure, activate, and/or perform both configuration and/or activation of TCI configuration. Such nodes may include the serving cell and/or a controlling node of the Tx WTRU. That WTRU may configure TCI information into the Tx WTRU with or without assistance information from Rx WTRU and/or serving cell of the Rx WTRU. The serving cell and/or a controlling node of the Tx WTRU may activate the pre-configured TCI information into the Tx WTRU with or without assistance information from the Rx WTRU and/or the serving cell of the Rx WTRU.

Additional nodes that may transmit a source RS include the serving cell and/or a controlling node of the Rx WTRU that may configure TCI information into the Rx WTRU with or without assistance information from the Tx WTRU and/or the serving cell of the Tx WTRU. The serving cell or a controlling node of the Rx WTRU may activate the pre-configured TCI information into the Rx WTRU with or without assistance information from the Tx WTRU and/or the serving cell of the Tx WTRU.

The Tx WTRU (e.g., a helper or an assisting node of a Tx WTRU) that may configure TCI information into the RX WTRU with or without assistance information from the Rx WTRU and/or the serving cell of the Rx WTRU. The Tx WTRU (e.g., a helper or an assisting node of a Tx WTRU) may activate pre-configured TCI information into the RX WTRU with or without assistance information from the Rx WTRU and/or the serving cell of the Rx WTRU.

The Rx WTRU (e.g., a helper or an assisting node of a Rx WTRU) that may configure TCI information into the Tx WTRU with or without assistance information from the Rx WTRU and/or the serving cell of the Rx WTRU. The Rx WTRU (e.g., a helper or an assisting node of a Rx WTRU) may activate pre-configured) TCI information into the Tx WTRU with or without assistance information from the Rx WTRU and/or the serving cell of the Rx WTRU.

In examples, a WTRU may perform beam and TCI adaptation (e.g., in shared spectrum to increase reception opportunities, enhance performance, and/or reduced signaling overhead). The WTRU may be pre-configured for TCI configuration. Depending on the CU, the SL S-TCI mode indicator may be set properly. If CUIs high, then the SL S-TCI mode indicator in the first stage SCI may be set to “enabled.” If CU is low, then the SL S-TCI mode indicator in the first stage SCI may be set to “disabled.”

A WTRU may be indicated TCI (e.g., via SL MAC CE) to receive the first stage SCI and/or second stage SCI. The WTRU may receive the first stage SCI and/or obtain SL P-TCI(s). If the SL S-TCI mode indicator is configured, then the WTRU may further check the CU. If the CU is high, then the SL S-TCI mode indicator is set to “enabled.” If the CU is low, then the SL S-TCI mode indicator may be set to “disabled.”

When the WTRU receives the first stage SCI, the WTRU may check the SL S-TCI mode indicator in a control field of the first stage SCI. The WTRU may receive the second stage SCI to obtain additional TCI information. If the SL S-TCI mode indicator in the first stage SCI indicates “enabled,” then the SL S-TCI mode indicator may check additional control field and obtain additional TCIs (e.g., SL S-TCI(s) in the second stage SCI). The WTRU may receive a PSSCH using both SI P-TCI(s) and/or SL S-TCI(s) to increase reception opportunities and/or enhance performance.

If the SL S-TCI mode indicator in the first stage SCI indicates “disabled,” then an additional control field for SL S-TCI may not be present. The WTRU may not obtain SL S-TCI in the second stage SCI. The WTRU may receive a PSSCH using SL P-TCI(s) (e.g., only the SL P-TCI(s) to reduce signaling overhead.

If the SL S-TCI mode indicator is not configured, then the WTRU may not check CU. An additional control field for the SL S-TCI may not be present. The WTRU may not obtain the SL S-TCI in the second stage SCI. The WTRU may receive a PSSCH using SL P-TCI(s) (e.g., only the SL P-TCI(s).

In examples, the WTRU performs beam and/or TCI adaptation (e.g., in shared spectrum to increase reception opportunities, enhance performance, and/or reduced signaling overhead). The WTRU may be pre-configured for TCI configuration. Depending on the CU, SL S-TCI mode indicator may be set properly. If the CU is high, then the SL S-TCI mode indicator in the first stage SCI may be set to “enabled.” If the CU is low, then the SL S-TCI mode indicator in the first stage SCI may be set to “disabled.” The WTRU may be indicated with TCI to receive the first stage SCI. The WTRU may receive the first stage SCI and obtain the SL P-TCI(s). The WTRU may receive second stage SCI using indicated SL P-TCI(s). If the SL S-TCI mode indicator is configured, then the WTRU may further check CU. If the CU is high, then the SL S-TCI mode indicator is set to “enabled.” If the CU is low, then SL S-TCI mode indicator is set to “disabled.” The WTRU may receive the second stage SCI.

When a WTRU receives the first stage SCI, the WTRU may check the SL S-TCI mode indicator in control field of the first stage SCI. If the SL S-TCI mode indicator in the first stage SCI indicates “enabled,” then the WTRU may check additional control field and obtain additional TCIs (e.g., SL S-TCI(s) in the second stage SCI), The WTRU may receive a PSSCH using both the SL P-TCI(s) and SL S-TCI(s). If the SL S-TCI mode indicator in the first stage SCI indicates “disabled,” then an additional control field for the SL S-TCI may not be present. The WTRU may not obtain SL S-TCI in the second stage SCI. The WTRU may receive a PSSCH using the SL P-TCI(s) (e.g., only the SL P-TCI(s). If the SL S-TCI mode indicator is not configured, then the WTRU may not check the CU. An additional control field for the SL S-TCI may not be present. The WTRU may not obtain SL S-TCI in the second stage SCI. The WTRU may receive a PSSCH using SL P-TCI(s) (e.g. only the SL P-TCI(s).

The CU may be determined based on any combination of a plurality of factors, including: a number of LBT failures, ratio of LBT failures to total measurements, ratio of LBT failures to successes, NACK to ACK ratio, percentage of NACKs, channel busy ratio (CBR), interference level, and/or the like.

The methods and solutions described in the application may be applied to reception of a sidelink data channel, sidelink control channel, sidelink reference signal, other signals or channels, and/or the like. The methods and solutions described herein may be applied to a transmission of sidelink data channel, sidelink control channel, sidelink feedback channel, sidelink reference signal, other signals or channels, and/or the like. The methods and solutions described herein may be applied to different cast types such as unicast, groupcast, multicast, and/or the like. The methods and solutions described herein may be applied to unlicensed spectrum, shared spectrum, licensed spectrum, and/or the like. The methods and solutions described herein may be applied to reception and/or transmission of a single stage, two-stage and/or multi-stage communications, for example, a two stage sidelink control channel (e.g., the first stage SCI and/or second stage SCI).

1-18. (canceled)

19. A wireless transmit/receive unit (WTRU) comprising:
a processor and memory, wherein the processor and memory are configured to:
receive a first stage sidelink control information (SCI) that indicates one or more sidelink (SL) primary transmission configuration indications;
determine whether to enable or disable an SL secondary transmission configuration indication mode for a second stage SCI based on channel uncertainty;
receive the second stage SCI;
in response to the SL secondary transmission configuration indication mode being enabled for the second stage SCI, determine one or more SL secondary transmission configuration indications using the second stage SCI; and
receive a sidelink transmission using the one or more SL primary transmission configuration indications and using, based on the SL secondary transmission configuration indication mode being enabled for the second stage SCI, the one or more SL secondary transmission configuration indications.

20. The WTRU of claim 19, wherein the processor and memory are further configured to determine the channel uncertainty based on one or more channel uncertainty measurements.

21. The WTRU of claim 20, wherein the processor and memory are further configured to determine that the channel uncertainty is high based on the one or more channel uncertainty measurements being greater than a predetermined threshold.

22. The WTRU of claim 21, wherein the processor and memory are further configured to enable the SL secondary transmission configuration indication mode based on the channel uncertainty being determined as high.

23. The WTRU of claim 21, wherein the processor and memory are further configured to disable the SL secondary transmission configuration indication mode based on the channel uncertainty being determined as low.

24. The WTRU of claim 20, wherein the one or more channel uncertainty measurements comprises one or more of a number of listen before talk (LBT) failures, a ratio of LBT failures to total measurements, a ratio of LBT failures to successes, a negative acknowledgment (NACK) to acknowledgment (ACK) ratio, a percentage of NACKs, a channel busy ratio (CBR), or an interference level.

25. The WTRU of claim 19, wherein the one or more SL secondary transmission configuration indications are determined based on a control field in the second stage SCI.

26. The WTRU of claim 19, wherein the second stage SCI is received using the one or more SL primary transmission configuration indications.

27. The WTRU of claim 19, wherein the processor and memory are further configured to receive an SL medium access control (MAC) control element (CE) that indicates an SL secondary transmission configuration indication to be used to receive the first stage SCI and the second stage SCI.

28. A method performed by a wireless transmit/receive unit (WTRU), the method comprising:
receiving a first stage sidelink control information (SCI) that indicates one or more sidelink (SL) primary transmission configuration indications;
determining whether to enable or disable an SL secondary transmission configuration indication mode for a second stage SCI based on channel uncertainty;
receiving the second stage SCI;
in response to the SL secondary transmission configuration indication mode being enabled for the second stage SCI, determining one or more SL secondary transmission configuration indications using the second stage SCI; and
receiving a sidelink transmission using the one or more SL primary transmission configuration indications and using, based on the SL secondary transmission configuration indication mode being enabled for the second stage SCI, the one or more SL secondary transmission configuration indications.

29. The method of claim 28, further comprising determining the channel uncertainty based on one or more channel uncertainty measurements.

30. The method of claim 29, further comprising determining that the channel uncertainty is high based on the one or more channel uncertainty measurements being greater than a predetermined threshold.

31. The method of claim 30, further comprising enabling the SL secondary transmission configuration indication mode based on the channel uncertainty being determined as high.

32. The method of claim 30, further comprising disabling the SL secondary transmission configuration indication mode based on the channel uncertainty being determined as low.

33. The method of claim 29, wherein the one or more channel uncertainty measurements comprises one or more of a number of listen before talk (LBT) failures, a ratio of LBT failures to total measurements, a ratio of LBT failures to successes, a negative acknowledgment (NACK) to acknowledgment (ACK) ratio, a percentage of NACKs, a channel busy ratio (CBR), or an interference level.

34. The method of claim 28, wherein the one or more SL secondary transmission configuration indications are determined based on a control field in the second stage SCI.

35. The method of claim 28, wherein the second stage SCI is received using the one or more SL primary transmission configuration indications.

36. The method of claim 28, further comprising receiving a medium access control (MAC) control element (CE) that indicates an SL secondary transmission configuration indication to be used to receive the first stage SCI and the second stage SCI.

37. The WTRU of claim 19, wherein the wherein the processor and memory are further configured to:
receive configuration information that comprises an SL secondary transmission configuration indication mode indicator associated with the SL secondary transmission configuration indication mode; and
in response to determining whether to enable or disable the SL secondary transmission configuration indication mode for the second stage SCI based on channel uncertainty, set the SL secondary transmission configuration indication mode indicator to indicate whether the SL secondary transmission configuration indication mode is enabled or disabled.

38. The method of claim 28, further comprising:
receiving configuration information that comprises an SL secondary transmission configuration indication mode indicator associated with the SL secondary transmission configuration indication mode; and
in response to determining whether to enable or disable the SL secondary transmission configuration indication mode for the second stage SCI based on channel uncertainty, setting the SL secondary transmission configuration indication mode indicator to indicate whether the SL secondary transmission configuration indication mode is enabled or disabled.
